(19) United States
(12) Patent Application Publication
(10) Pub. No.: US 2026/0106973 A1
(43) Pub. Date: Apr. 16, 2026

(54) ENCODING AND DECODING METHODS USING DIRECTIONAL INTRA PREDICTION AND CORRESPONDING APPARATUSES

(71) Applicant: InterDigital CE Patent Holdings, SAS, Paris (FR)

(72) Inventors: Thierry Dumas, Rennes (FR); Kevin Reuze, Rennes (FR); Philippe Bordes, Laille (FR); Franck Galpin, Thorigne-Fouillard (FR)

(21) Appl. No.: 19/122,144

(22) PCT Filed: Oct. 10, 2023
(86) PCT No.: PCT/EP2023/078013

§ 371 Date: Apr. 17, 2025

(30) Foreign Application Priority Data
Oct. 20, 2022 (EP) 22306594.7
Dec. 9, 2022 (EP) 22306834.7

(51) Int. Cl. H04N 19/11; H04N 19/176; H04N 19/70

(52) U.S. Cl. CPC H04N 19/11; H04N 19/176; H04N 19/70

(57) ABSTRACT

Encoding and decoding methods are disclosed wherein directional intra prediction is used. Each directional intra prediction mode of a given set is associated (S100) with a sum of gradient's values associated with pixels whose direction perpendicular to gradient's direction is the closest to a direction of said directional intra prediction mode and with information representative of a spatial position of each pixel contributing to the sum. At least two directional intra prediction modes are selected (S102) associated with the sums of largest amplitude and at least two predictions of said current picture block are obtained (S107) from them. Finally: the at least two predictions are blended (S108) based on information representative of a spatial position of at least one pixel contributing to the sum associated with at least one of said selected directional intra prediction modes. The current picture block is reconstructed (S110) from the blended prediction.

### CROSS REFERENCE TO RELATED APPLICATIONS

This application claims the benefit of European Application No. 22306594.7, filed on Oct. 20, 2022, and of European Application No. 22306834.7, filed on Dec. 9, 2022 which are incorporated herein by reference in their entirety.

### TECHNICAL FIELD

At least one of the present examples generally relates to a method and an apparatus for encoding and decoding a picture block using directional intra prediction.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

In one implementation, at least two predictions of a picture block are obtained from selected intra prediction modes. The at least two predictions are blended based on at least one location of a pixel that contributed to the selection of the intra prediction modes. The picture block may thus be reconstructed (encoded respectively) from the blended prediction. Histogram of oriented gradients may be used to select the intra prediction modes. The blending may use blending matrices.

### BRIEF DESCRIPTION OF THE DRAWINGS

FIG. 1 illustrates a block diagram of a system within which aspects of the present examples may be implemented;

FIG. 2 illustrates a block diagram of an example of a video encoder:

FIG. 3 illustrates a block diagram of an example of a video decoder;

FIG. 4 illustrates the principles of gradient extraction in a L-shaped context of a current block to be predicted:

FIG. 5 illustrates the identification of the range of the target intra prediction mode index from the absolute values of G_{VER} and G_{HOR} and the signs of G_{VER} and G_{HOR};

FIG. 6 and FIG. 7 illustrate the computation of the angle θ between the reference axis and the direction being perpendicular to the gradient G of components G_{VER} and G_{HOR}:

FIG. 8 and FIG. 9 illustrate the computation of an index of the target intra prediction mode:

FIG. 10 depicts DIMD (Decoder Side Intra Mode Derivation) regions used to infer the location dependency of DIMD modes:

FIGS. 11A to 11H depict flowchart of method for reconstructing a current picture block according to various examples:

FIGS. 12-15 illustrate incrementation of bins of Histogram Of Gradients according to various examples:

FIGS. 16-19 illustrate the selection of most relevant positions for blending according to various examples:

FIGS. 20-23 depict several blending matrices defined from one single pixel's position according to various examples.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

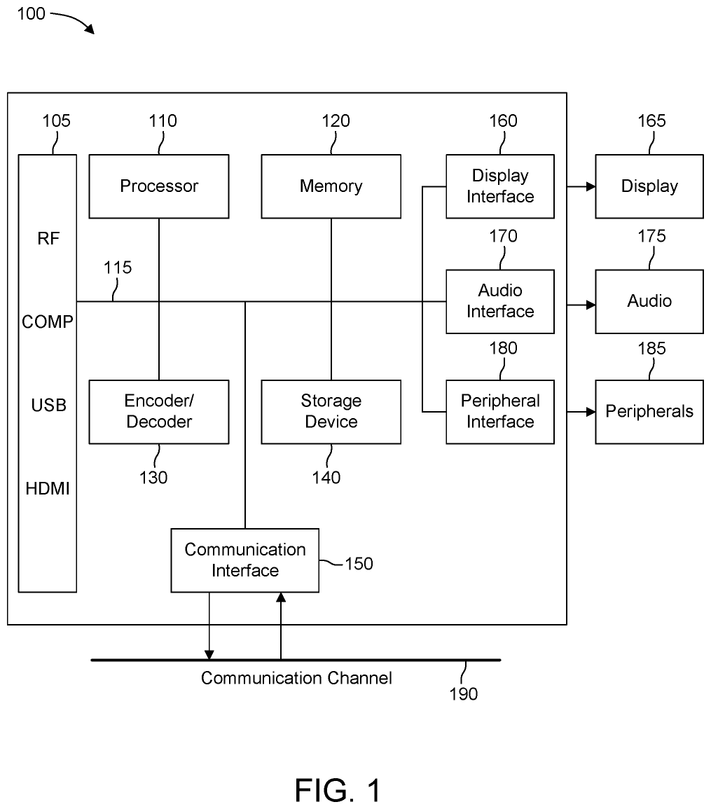

The aspects described and contemplated in this application can be implemented in many different forms. FIGS. 1, 2 and 3 below provide some examples, but other examples are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and examples can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one example, the processing and encoder/decoder elements of system 100 are distributed across multiple ICs and/or discrete components. In various examples, the system 100 is communicatively coupled to other systems, or to other electronic devices, via, for example, a communications bus or through dedicated input and/or output ports. In various examples, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various examples, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some examples, memory inside of the processor 110 and/or the encoder/decoder module 130 is used to store instructions and to provide working memory for processing that is needed during encoding or decoding. In other examples, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several examples, an external non-volatile flash memory is used to store the operating system of a television. In at least one Example, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various examples, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in some examples, (iv) demodulating the down converted and band-limited signal. (v) performing error correction, and (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box Example, the RF portion and its associated input processing element receives an RF signal transmitted over a wired (for example, cable) medium, and performs frequency selection by filtering, down converting, and filtering again to a desired frequency band. Various examples rearrange the order of the above-described (and other) elements, remove some of these elements, and/or add other elements performing similar or different functions. Adding elements may include inserting elements in between existing elements, for example, inserting amplifiers and an analog-to-digital converter. In various examples, the RF portion includes an antenna.

Additionally, the USB and/or HDMI terminals may include respective interface processors for connecting system 100 to other electronic devices across USB and/or HDMI connections. It is to be understood that various aspects of input processing, for example. Reed-Solomon error correction, may be implemented, for example, within a separate input processing IC (Integrated Circuit) or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130) operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various examples, using a Wi-Fi network such as IEEE 802.11 (IEEE refers to the Institute of Electrical and Electronics Engineers). The Wi-Fi signal of these examples is received over the communications channel 190 and the communications interface 150 which are adapted for Wi-Fi communications. The communications channel 190 of these examples is typically connected to an access point or router that provides access to outside networks including the Internet for allowing streaming applications and other over-the-top communications. Other examples provide streamed data to the system 100 using a set-top box that delivers the data over the HDMI connection of the input block 105. Still other examples provide streamed data to the system 100 using the RF connection of the input block 105. As indicated above, various examples provide data in a non-streaming manner. Additionally, various examples use wireless networks other than Wi-Fi, for example a cellular network or a Bluetooth network.

The system 100 may provide an output signal to various output devices, including a display 165, speakers 175, and other peripheral devices 185. The display 165 of various examples includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of examples, one or more of a stand-alone digital video disc (or digital versatile disc) (DVR, for both terms), a disk player, a stereo system, and/or a lighting system. Various examples use one or more peripheral devices 185 that provide a function based on the output of the system 100. For example, a disk player performs the function of playing the output of the system 100.

In various examples, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various examples, the display interface 160 includes a display driver, for example, a timing controller (T Con) chip.

The display 165 and speaker 175 may alternatively be separate from one or more of the other components, for example, if the RF portion of input block 105 is part of a separate set-top box. In various examples in which the display 165 and speakers 175 are external components, the output signal may be provided via dedicated output connections, including, for example, HDMI ports, USB ports, or COMP outputs.

The examples can be carried out by computer software implemented by the processor 110 or by hardware, or by a combination of hardware and software. As a non-limiting example, the examples can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

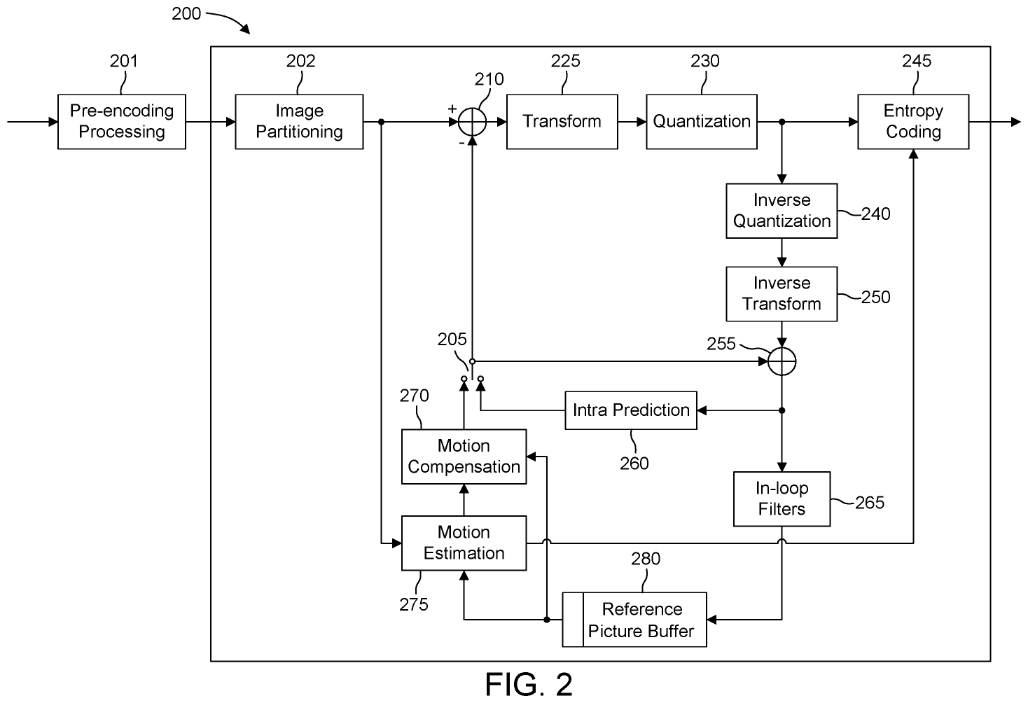

FIG. 2 illustrates an example video encoder 200 (e.g. an encoding apparatus), such as a VVC (Versatile Video Coding) encoder. FIG. 2 may also illustrate an encoder in which improvements are made to the VVC standard or an encoder employing technologies similar to VVC.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260), e.g. using an intra-prediction tool such as Decoder Side Intra Mode Derivation (DIMD). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

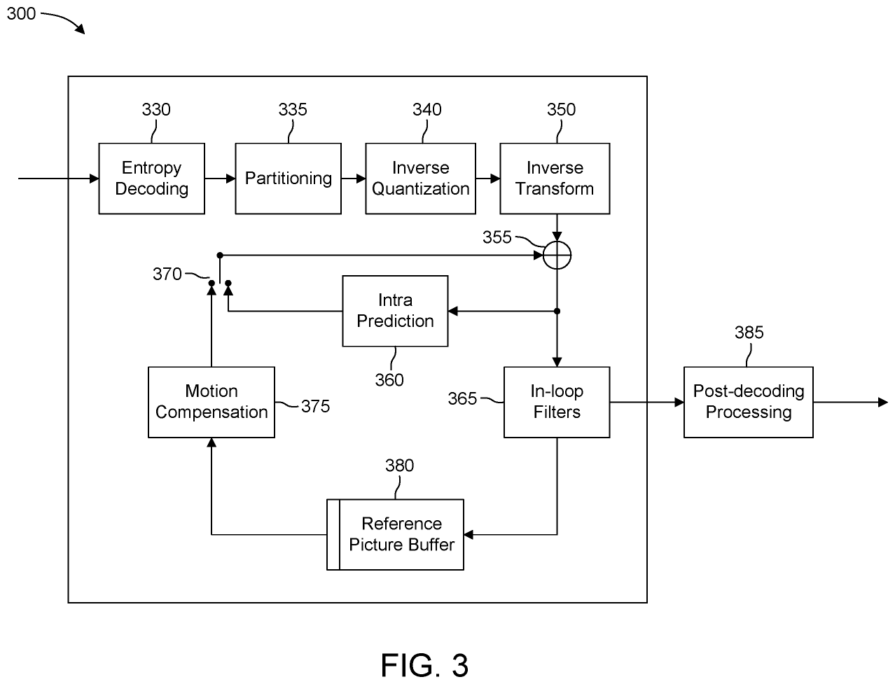

FIG. 3 illustrates a block diagram of an example video decoder 300 (e.g. a decoding apparatus). In the decoder 300, a bitstream is decoded by the decoder elements as described below: Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

Decoder-Side Intra Mode Derivation (DIMD) relies on the assumption that the decoded pixels surrounding a given block to be predicted carries information to infer the texture directionality in this block, i.e. the intra prediction modes that most likely generate the predictions with the highest qualities. In the following, all the disclosed features apply the same way on both the encoder and decoder sides.

In ECM-6.0 (acronym of “Enhanced Compression Model”), DIMD is implemented as disclosed in the following sections.

### Inference in DIMD as Implemented in ECM-6.0

The inference of the indices of the intra prediction modes that most likely generate the predictions of highest qualities according to DIMD is decomposed into three steps. First, gradients are extracted from a context, e.g. a L-shape template, of decoded pixels around a given block to be predicted for encoding or decoding. Then, these gradients are used to fill a Histogram of Oriented Gradients (HOG). Finally, the indices of the intra prediction modes that most likely give the predictions with highest qualities are derived from this HOG, and a blending may be performed. A blending is for example a weighted sum of the predictions.

Extraction of Gradients from the Context

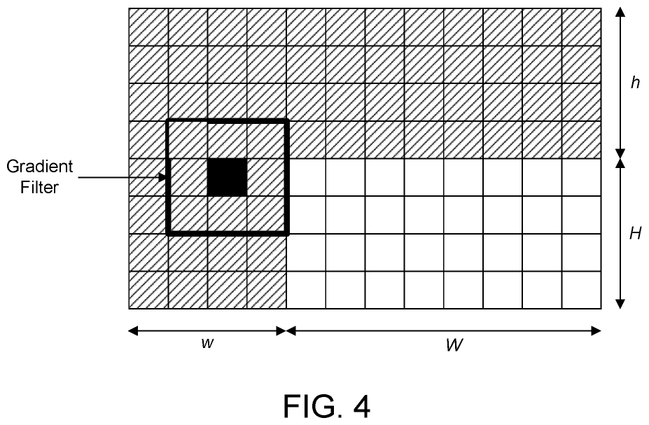

For a given block to be predicted, a L-shape context (also called template) of h rows of decoded pixels above this block and w columns of decoded pixels on the left side of this block is considered as depicted on FIG. 4. On this Figure, the block to be predicted is displayed in white, the context of this block is hatched and the gradient filter is framed in black. At each decoded pixel of interest in this context, a local vertical gradient and a local horizontal gradient are computed. In ECM-6.0, the local vertical and horizontal gradients are computed via 3×3 vertical and horizontal Sobel filters respectively. Moreover, in ECM-6.0, a decoded pixel of interest in this context refers to a decoded pixel at which the gradient filter does not go out of the context bounds. Therefore, in ECM-6.0, the complete extraction of gradients can be summarized by the “valid” convolution of the 3×3 vertical and horizontal Sobel filters with the context. Note that, in ECM-6.0, h=3 and w=3.

### Filing the Histogram of Oriented Gradients (HOG)

In the HOG, each bin is associated with the index of a different directional intra prediction mode. At initialization, all the HOG bins are equal to 0). For each decoded pixel of interest at which the local vertical gradient G_{VER} and the local horizontal gradient G_{HOR} are computed, a direction is derived from G_{VER} and G_{HOR}, and the bin associated with the index of the directional intra prediction mode whose direction is the closest to the derived direction is incremented. This index is called the “target intra prediction mode index”.

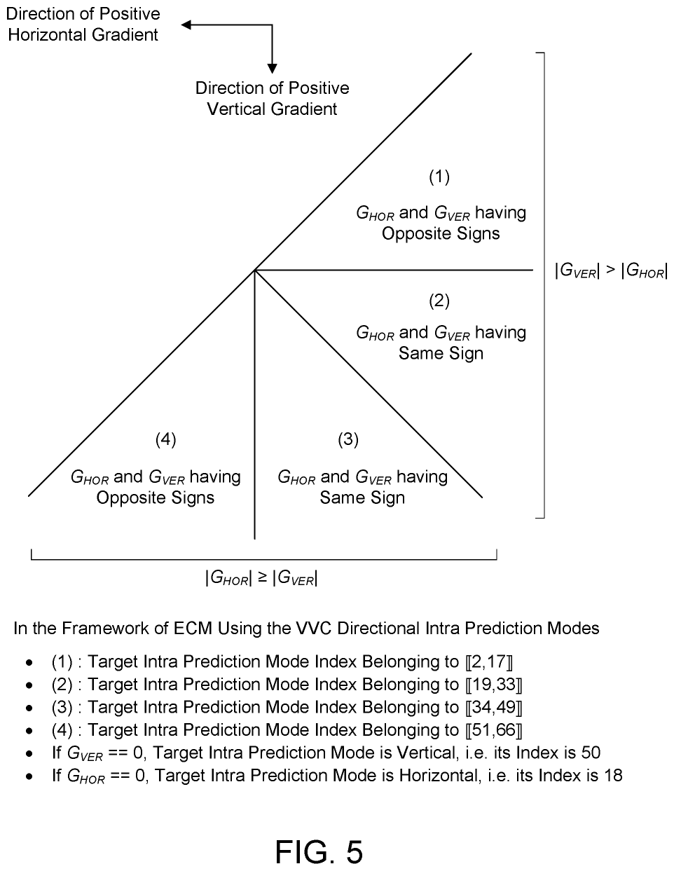

More precisely, for a given decoded pixel of interest, the derivation of the direction from G_{VER} and G_{HOR} is based on the following observation. During the prediction of a block via a directional intra prediction mode, the largest gradient in absolute value usually follows the perpendicular to the mode direction. Therefore, the direction derived from G_{VER} and G_{HOR} IS perpendicular to the gradient of components G_{VER} and G_{HOR}. For instance, in ECM-6.0 using the 65 VVC directional intra prediction modes, considering vertical and horizontal gradient filters for which the direction of positive vertical gradient goes from top to bottom and the direction of positive horizontal gradient goes from right to left, the mapping from the absolute values of G_{VER} and G_{HOR} and the signs of G_{VER} and G_{HOR} to the range of the target intra prediction mode index is illustrated on FIG. 5. In the framework of ECM using VVC directional intra prediction modes. In the case (1), the target intra prediction mode index belongs to the set [[2,17]]. In case (2), the target intra prediction mode index belongs to the set [[19,33]]. In the case (3), the target intra prediction mode index belongs to the set [[34, 49]]. In the case (3), the target intra prediction mode index belongs to the set [[51, 66]]. If G_VER is equal to 0), the target intra prediction mode is vertical, i.e. its index is 50. If G_HOR is equal to 0, the target intra prediction mode is horizontal, i.e. its index is 18.

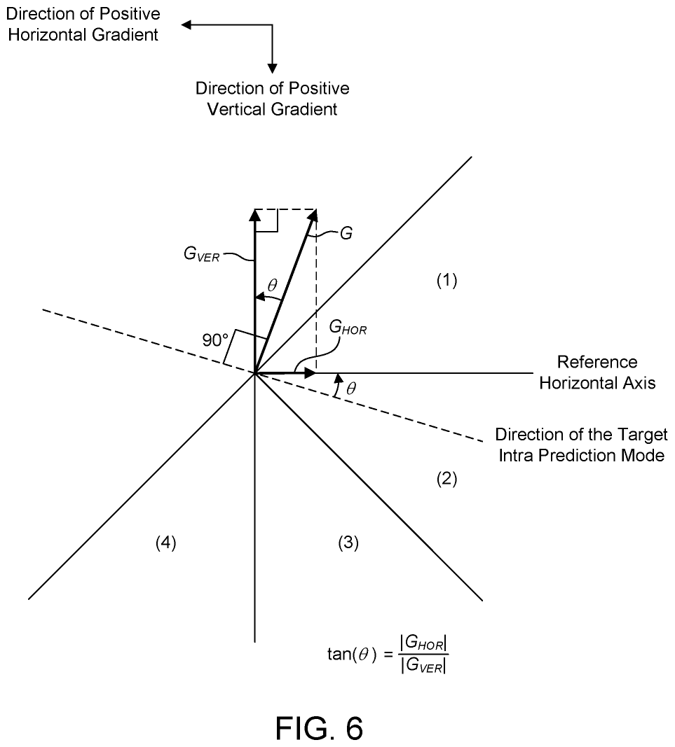

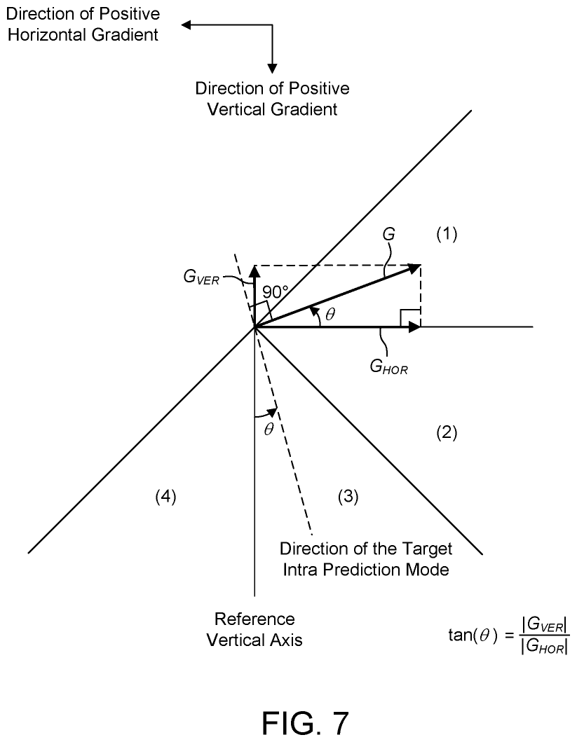

If |G_{VER}|>|G_{HOR}|, the reference axis is the horizontal axis. Otherwise, the reference axis is the vertical axis. The angle θ between the reference axis and the direction being perpendicular to the gradient G of components G_{VER} and G_{HOR} is given by tan(θ)=|G_{HOR}|/|G_{VER}| if |G_{VER}|>|G_{HOR}|, tan(θ)=|G_{VER}|/|G_{HOR}| otherwise. This is illustrated in FIGS. 6 and 7.

For the current decoded pixel of interest at which the local vertical gradient G_{VER} and the local horizontal gradient G_{HOR} are computed, for the range of intra prediction mode indices found as in FIG. 5 it is now possible to find the index of the intra prediction mode whose angle with respect to the reference axis is the closest to θ. The bin associated with the index of the found target intra prediction mode is then incremented by |G_{HOR}|+|G_{VER}|. This means that, by denoting i the bin associated with the index of the found target intra prediction mode, HOG[i]=HOG[i]+|G_{HOR}|+|G_{VER}|. Note that, for the current decoded pixel of interest, if G_{HOR}=G_{VER}=0, no bin in the HOG is incremented.

### Angle Discretization

For a given decoded pixel at which the local vertical gradient G_{VER} and the local horizontal gradient G_{HOR} are computed, for the found range of the target intra prediction mode index (see FIG. 5) the angle θ previously mentioned is not directly compared to the angle of each intra prediction mode with respect to the reference axis in this range. Indeed, the absolute angle of each intra prediction mode with respect to its reference axis is stored in a scaled integer form. Therefore, \dot{θ}=floor (tan(θ)×(1<<16)) is compared to the scaled integer form Aᵢ of the angle of the directional intra prediction mode of index i from the reference axis, i∈[|0, 16|]. floor denotes the floor operation. Then, the absolute shift i_{shift} from the index of the reference axis to the index of the target intra prediction mode is

$${i}_{shift} = {min}_{i} \vert {A}_{i} - \dot{θ} \vert .$$

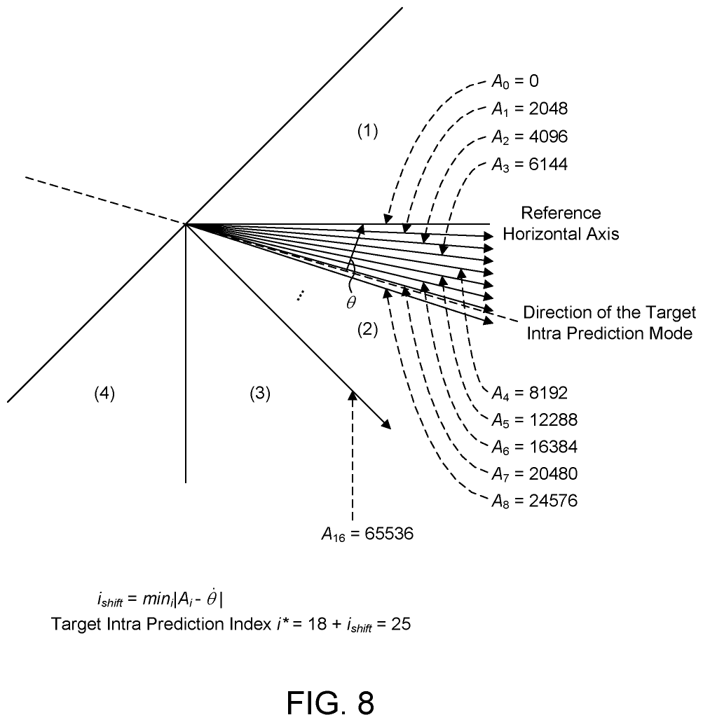

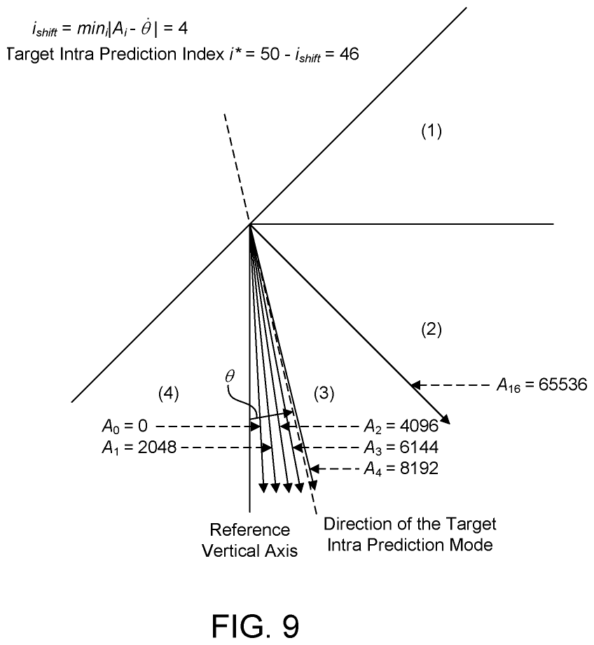

The target intra prediction mode index is finally equal to the index of the reference axis shifted by i_{shift}. In the conditions of FIG. 6, FIG. 8 illustrates the computation of the index of the target intra prediction mode using the above-mentioned discretization of θ. In the conditions of FIG. 7, FIG. 9 presents the computation of the index of the target intra prediction mode using the above-mentioned discretization of θ.

### Inference of the Intra Prediction Mode(s)

Once the filling of the HOG is completed, the index of the directional intra prediction mode that most likely generates the prediction with the highest quality is the one associated with the bin of largest, i.e. highest magnitude (also called amplitude). In ECM-6.0, the two bins with the largest magnitudes are identified to find indices of the directional intra prediction modes (called primary and secondary directional intra prediction modes or more simply primary and secondary DIMD modes) that most likely yield the two DIMD predictions with the highest qualities according to DIMD. A prediction block, i.e. a DIMD prediction, is derived for each of these two modes and the obtained prediction blocks are linearly combined. The weights used in the linear combination may be derived from the values of the two identified bins, i.e. the two bins with the largest magnitudes. In ECM-6.0, these two prediction blocks are further combined with a third prediction block obtained with the PLANAR mode. In this case, the weight associated with the prediction block obtained from the primary directional intra prediction mode is equal to the value of the bin of largest magnitude normalized by the sum of the values of the two bins of largest magnitudes and the weight attributed to the prediction block from the PLANAR mode. The weight associated with the prediction block obtained from the secondary directional intra prediction mode is equal to the bin of second largest magnitude normalized by the sum of the values of the two bins of largest magnitudes and the weight attributed to the prediction block from the PLANAR mode. The same weight is applied to all pixels of each DIMD prediction.

### Signaling of DIMD in ECM-6.0

In ECM-6.0, for a given luminance Coding Block (CB) to be predicted, DIMD is signaled via a DIMD flag, placed first in the decision tree of the signaling of the intra prediction mode selected to predict this luminance CB, i.e. before the Template-Matching Prediction (TMP) flag and the Matrix-based Intra Prediction (MIP) flag.

### Improved DIMD Using Sample-Based Weights to Blend the DIMD Predictions

In the previous example, the same weight is applied to all pixels of each DIMD prediction. DIMD may be improved by non-uniform, sample-based weights to blend the DIMD predictions, e.g. a weighted sum of the DIMD predictions. The usage of sample-based blending, and the specific weights to use for a given prediction, are inferred during the DIMD derivation process. When deriving a DIMD mode, it is determined whether the derivation of such mode was mostly influenced by the template region above or on the left of the current block. If a DIMD mode was mostly derived from samples above the current block, then when blending the corresponding prediction, higher weights should be used for samples closer to the above portion of the block.

This method thus makes the DIMD blending dependent on the regions containing the dominant absolute gradient intensities yielding the DIMD derived modes.

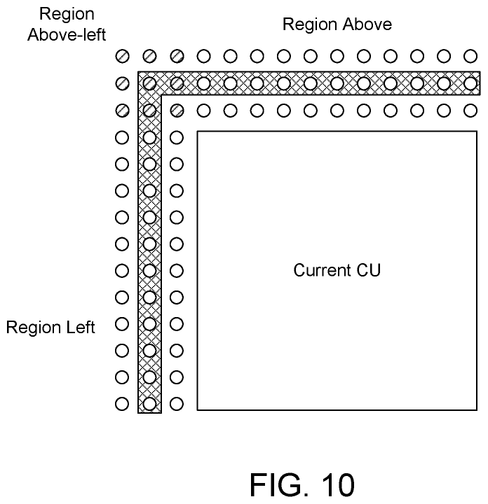

In order to determine whether specific samples in the template contribute to inferring specific DIMD modes, three separate regions are considered within the DIMD template as depicted on FIG. 10. The gradient computation is performed separately for samples in each region, resulting in three histograms, H_{above}, H_{left} and H_{aboveLeft} respectively. For a directional mode m, H_{above}[m] represents the cumulative magnitude of all samples in the region ABOVE at direction m. It should be noticed that the template area is extended by one sample on the top-left and one sample on the bottom-right, with respect to conventional DIMD (i.e. as defined in ECM-6.0).

The full histogram of gradients for the whole template can then be computed as the sum of the three separate histograms. As in conventional DIMD, the two directional modes with largest and second-largest cumulative magnitude in the histogram are selected as main (also called primary) and secondary DIMD modes, dimdMode₀ and dimdMode₁, respectively.

Additionally, the histograms H_{above} and H_{left} can be used to determine whether dimdMode₀ and/or dimdMode₁ depend on a specific template region ABOVE or LEFT. In particular, the location-dependency of dimdModeᵢ, denoted as locDepᵢ, can be defined as:

```
If: (H_{above}[dimdModeᵢ] > 2H_{left}[dimdModeᵢ]), then:
  locDepᵢ = 1, that is dimdModeᵢ depends on region ABOVE.
Else if: (H_{left}[dimdModeᵢ] > 2H_{above}[dimdModeᵢ]), then:
  locDepᵢ = 2, that is dimdModeᵢ depends on region LEFT.
Else:
  locDepᵢ = 0, that is dimdModeᵢ is not location-dependent.
```

Blending is then performed to fuse the main and secondary DIMD predictions obtained using the main and secondary DIMD modes respectively, dimdPred₀ and dimdPred₁, with the Planar prediction dimdPlanar. In case no DIMD mode is determined to be location-dependent (meaning locDep₀==locDep₁==0) then uniform blending is applied. Uniform weights wDimd₀, wDimd₁ and wPlanar are derived based on the relative magnitudes of the modes in the histogram, and the final DIMD prediction is computed as:

$$fusionPred ( x , y ) = ( {\sum }_{i = 0}^{1} \{ wDim {d}_{i} * {dimdPred}_{i} ( x , y ) \} + wPlanar * dimdPlanar ( x , y ) ) ≫ 6 \qquad ( Eq 1 )$$

Else, if at least one of the DIMD modes is inferred to be location-dependent, then sample-based blending is used. A different weight is used to blend the predictions at each location (x, y).

If locDepᵢ≠0 the sample-based weights wLocDepDimdᵢ(x, y) for prediction dimdPredᵢ are computed so that the average weight used within the block is approximately equal to the uniform weight wDimdᵢ and so that higher weights are used in the portion of the block closer to the region ABOVE or LEFT, depending on locDepᵢ. A range Δᵢ is pre-defined, corresponding to the largest deviation of wLocDepDimdᵢ(x, y) from wDimdᵢ. Higher values of Δᵢ result in a higher variation of the weights within the block. In particular for a block of size H×W, if locDepᵢ=1, then:

$${wLocDepDimd}_{i} ( x , y ) = {wDimd}_{i} + {Δ}_{i} - 2 {Δ}_{i} \frac{y}{( H - 1 )}$$

Else if locDepᵢ=2, then:

$${wLocDepDimd}_{i} ( x , y ) = {wDimd}_{i} + {Δ}_{i} - 2 {Δ}_{i} \frac{x}{( W - 1 )}$$

If both locDepᵢ≠0, i=0,1, then the weights wLocDepDimdᵢ(x, y) are computed for both predictions as in one of the two above equations, depending on the value of locDepᵢ. Conversely, if locDepᵢ=0 and locDep₍₁₋ᵢ₎≠0, then the weights for wLocDepDimdᵢ(x, y) are computed as:

$${wLocDepDimd}_{i} ( x , y ) = {wDimd}_{i} - \frac{{wLocDepDimd}_{( 1 - i )} ( x , y ) - {wDimd}_{( 1 - i )}}{2}$$

Finally, the weights for the Planar prediction wLocDepPlanar(x, y) are then computed as:

$$wLocDepPlanar ( x , y ) = 64 - {\sum }_{i = 0}^{1} \{ {wLocDepDimd}_{i} ( x , y ) \}$$

The final location-dependent DIMD prediction is then computed as:

$$fusionPred ( x , y ) = ( \begin{matrix}{\sum }_{i = 0}^{1} \{ {wLocDepDimd}_{i} ( x , y ) * {dimdPred}_{i} ( x , y ) \} + \\ + wLocDepPlanar ( x , y ) * dimdPlanar ( x , y ) + 32\end{matrix} ) ≫ 6 \qquad ( Eq 2 )$$

In the improved DIMD method disclosed above, within a given region around the current block (either ABOVE or LEFT or ABOVE-LEFT), the location of the gradients causing the incrementation of the HOG bin with the largest magnitude is not considered. Therefore, the improved DIMD method has the effect of a loss of information for DIMD blending. Indeed, for a current block, if the main contribution to the HOG bin with the largest magnitude arises from the gradient computation at a decoded pixel located at the rightmost of the ABOVE region, the pixel position inside the ABOVE region is lost when applying the DIMD blending.

In contrast, in the following examples, the location of the gradients causing the incrementation of the HOG bins is incorporated into the DIMD blending. For a given block on which DIMD applies, for each location in the DIMD context displayed in hatched in FIG. 4 at which a group of gradients is computed (as disclosed in the section entitled “Extraction of gradients from the context”), the resulting incrementation of a HOG bin (as disclosed in the sections entitled “Filling the HOG” and “angle discretization”), is paired with the storage of this location. Then, when picking the n E N HOG bins with largest magnitudes to get the n derived DIMD modes indices (as disclosed in the section entitled “Inference of the intra prediction mode(s)”) for each of these n bins, the location of each decoded pixel at which the gradient computation has led to an incrementation of this bin can be recovered. Finally, the retrieved locations drive the DIMD blending.

Therefore, the prediction of the current block to be encoded is improved without any additional signaling.

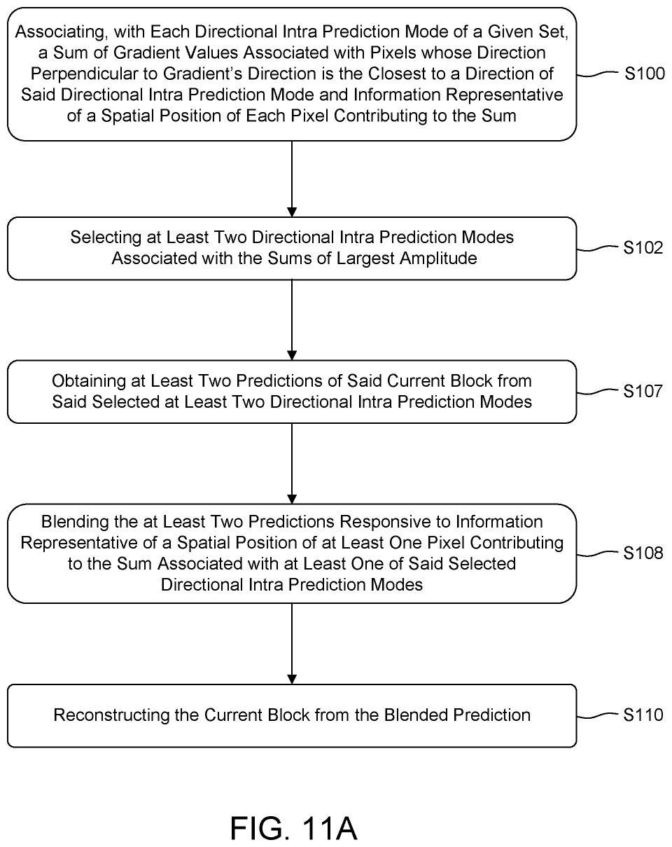

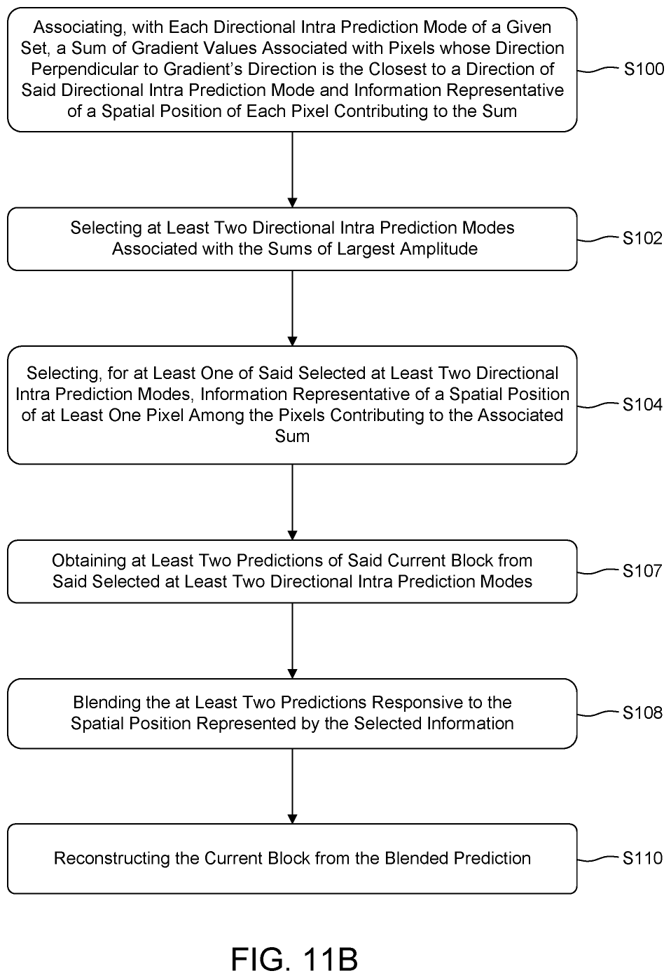

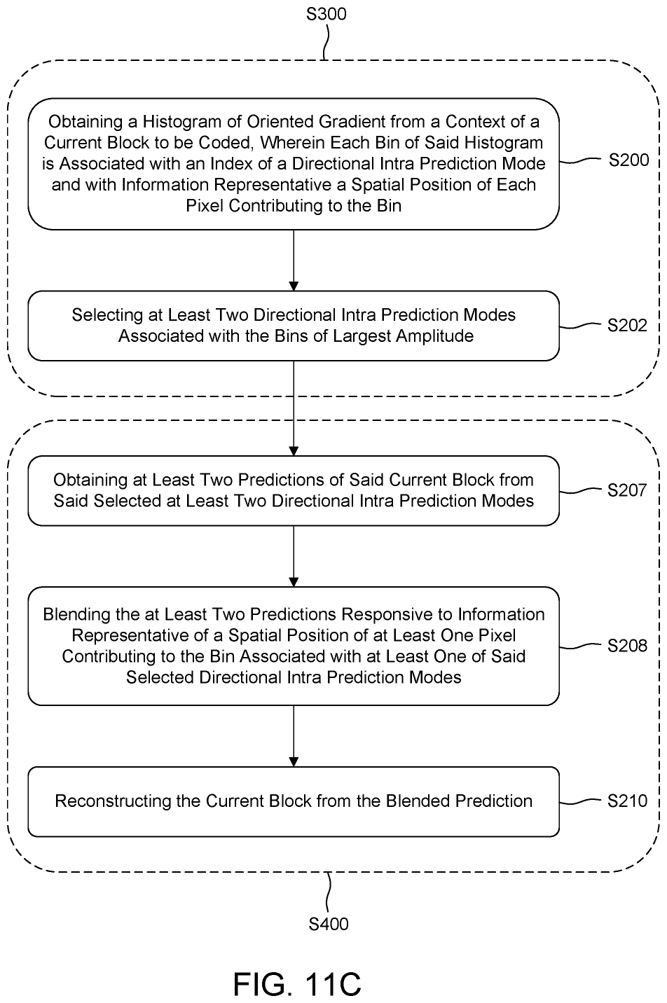

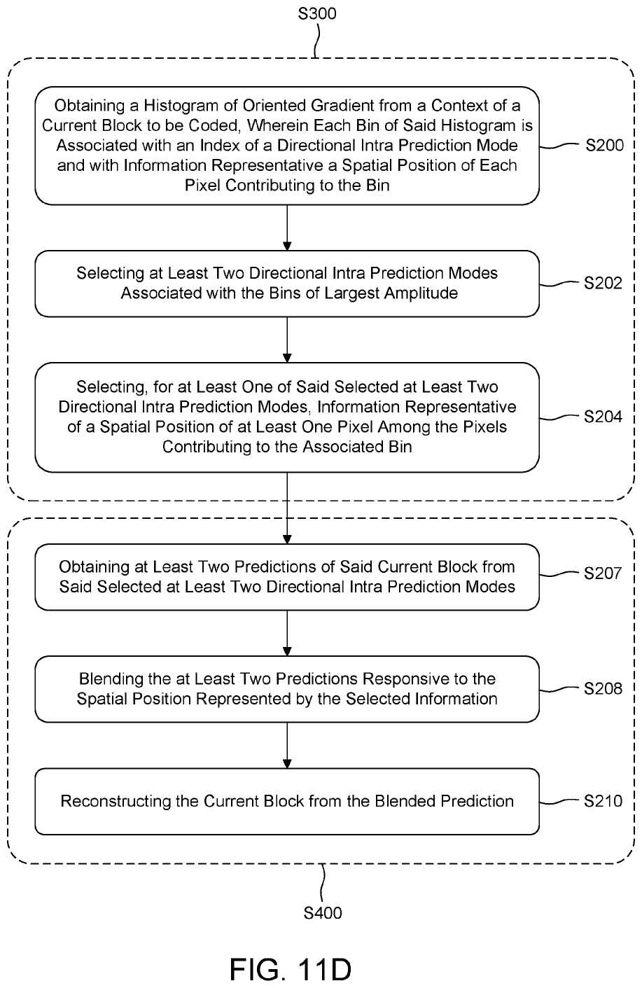

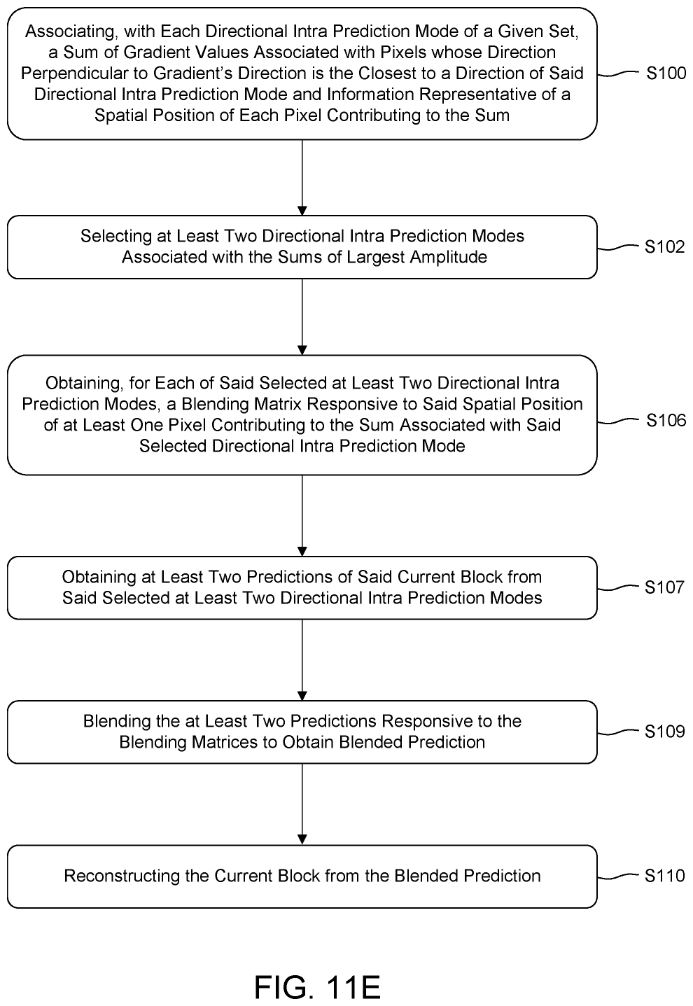

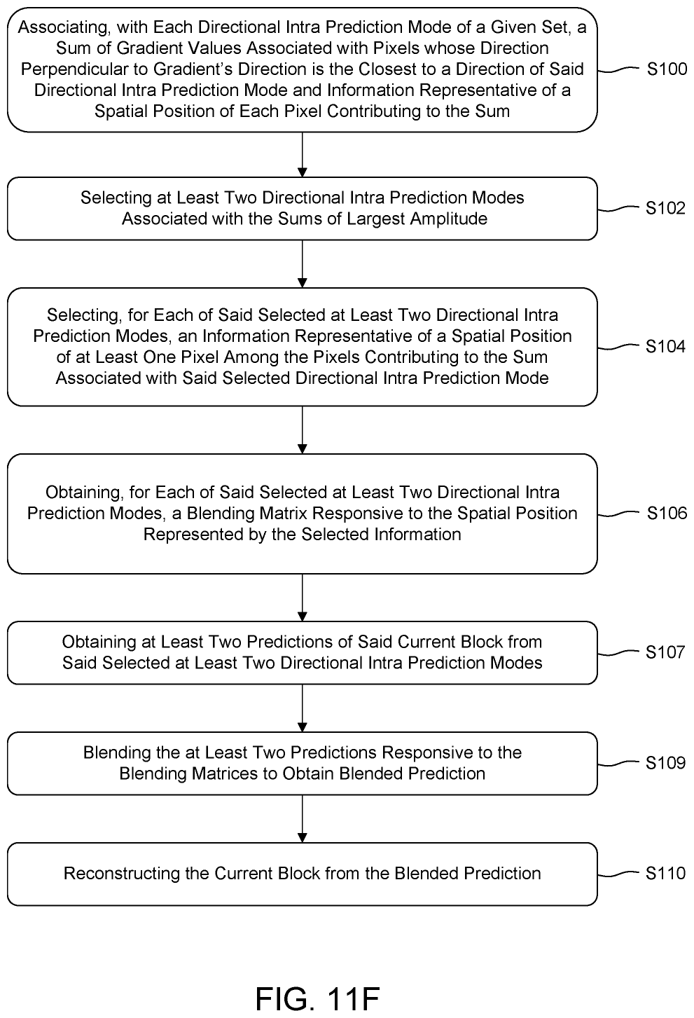

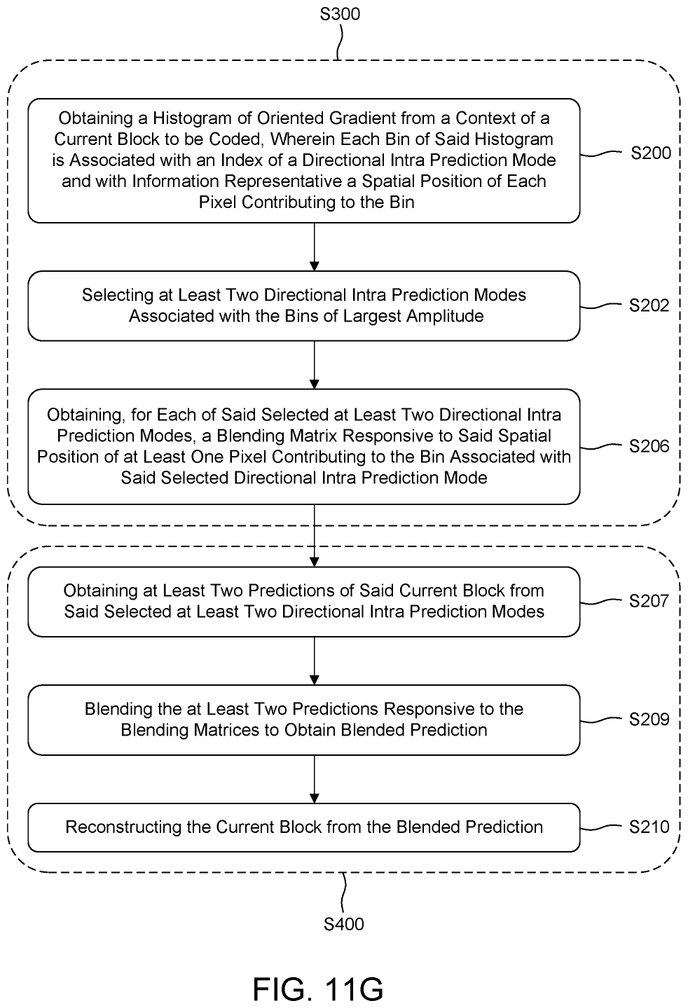

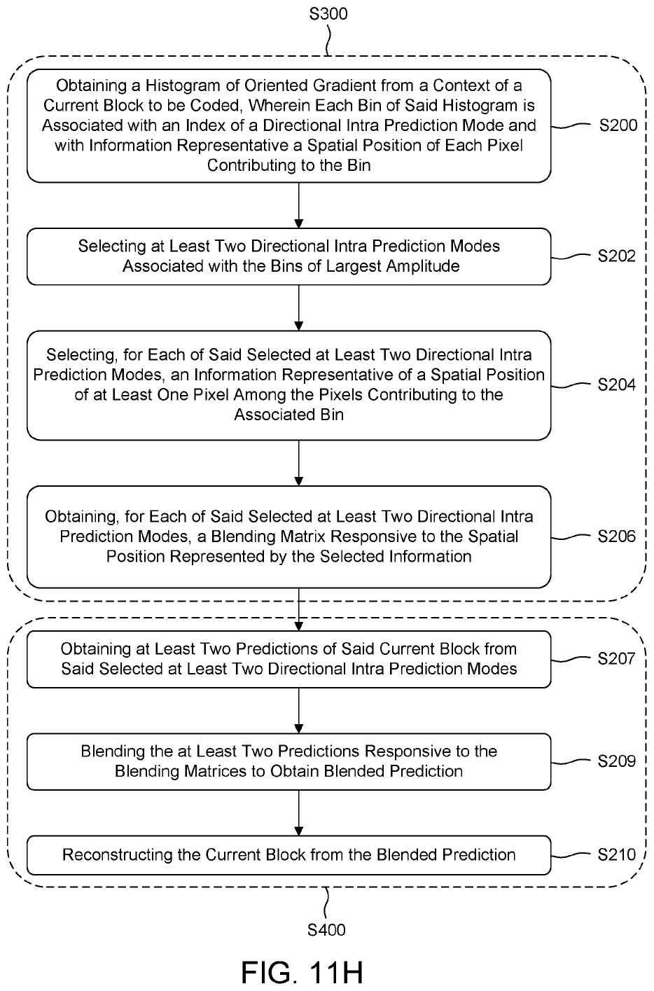

FIG. 11A is a flowchart of a method for reconstructing a picture block according to an example. The same method applies at both the encoder and decoder sides.

In a step S100, each directional intra prediction mode of a given set, e.g. the set of directional intra prediction modes defined in VVC, is associated with a sum of gradient values, e.g. |G_{HOR}|+|G_{VER}|, associated with pixels whose direction perpendicular to the gradient's direction is the closest to an orientation of said directional intra prediction mode and is further associated with information representative of a spatial position, e.g. spatial coordinates or more simply coordinates, of each pixel contributing to the sum. The considered pixels are located in context of a current picture block. The gradient values are for example equal to |G_{HOR}|+|G_{VER}|. However, the method is not limited to this value, e.g. \sqrt{|G_{HOR}|²+|G_{VER}|²} may be used instead. The associated values may be stored in a table or using an histogram.

As an example, for each decoded pixel of interest at which a local vertical gradient G_{VER} and a local horizontal gradient G_{HOR} are computed, a direction is derived from G_{VER} and G_{HOR} Which is perpendicular to the gradient's direction (i.e. the gradient's direction being the direction G of components G_{VER} and G_{HOR}), and the sum associated with the directional intra prediction mode whose direction is the closest to the derived direction is incremented.

In a step S102, at least two directional intra prediction modes associated with the sums of largest amplitude are selected.

In a step S107, at least two predictions of the current picture block are obtained from the selected at least two directional intra prediction modes.

In a step S108, the at least two predictions are blended based on (e.g. responsive to) information representative of a spatial position of at least one pixel contributing to the sum associated with at least one of said selected directional intra prediction modes. In an example, the at least two predictions are blended based on information representative of a spatial position of at least one pixel contributing to the sum associated with one of said selected directional intra prediction modes and further based on information representative of a spatial position of at least one pixel contributing to the sum associated with another one of said selected directional intra prediction modes. In a specific example, the at least two predictions are blended based on information representative of the spatial positions of all the pixels contributing to the sum associated with at least one of said selected directional intra prediction modes.

In a step S110, the current picture block is reconstructed from the blended prediction on the decoder side. The reconstruction of the current picture block comprises adding the blended prediction to a decoded residual.

On the encoder side, the steps S100 to S110 apply in the same way as on the decoder side as the encoder comprises a so-called decoding loop. The blended prediction is also further used to obtain a residual that is further encoded (quantized and entropy coded). More precisely, the residual is obtained by a pixelwise subtraction of the blended prediction from the current picture block to be encoded.

FIG. 11B is a flowchart of a method for reconstructing a picture block according to another example. The same method applies at both the encoder and decoder sides.

The method of FIG. 11B comprises the steps S100 to S102 and S107 to S110 of the method of FIG. 11A. It comprises an additional step S104. At step S104, for at least one (e.g. for each) of said selected at least two directional intra prediction modes, information representative of a spatial position of at least one pixel is selected among the pixels contributing to the associated sum.

The step S108 thus comprises blending the at least two predictions based on the spatial position represented by the information selected at step S104. More precisely, the at least two predictions are blended based on the information representative of a spatial position selected in S104.

FIG. 11C is a flowchart of a method for reconstructing a picture block according to an example. The same method applies at both the encoder and decoder sides.

In a step S200, a histogram of oriented gradient (HOG) is obtained from a context (also called template, e.g. a L-shape template), of a current picture block to be coded. Each bin of the histogram is associated with a directional intra prediction mode, e.g. with its index, and with information representative of a spatial position, e.g. coordinates, of each pixel contributing to the bin, also called reference location in the following sections. This example uses histogram of oriented gradient (HOG) to associate directional intra prediction modes with a sum of gradient's values.

In a step S202, at least two directional intra prediction modes associated with the bins of largest amplitude are selected.

In a step S207, at least two predictions of the current picture block are obtained from the selected at least two directional intra prediction modes.

In a step S208, the at least two predictions are blended based on information representative of a spatial position of at least one pixel contributing to the bin associated with at least one of said selected directional intra prediction modes. In an example, the at least two predictions are blended based on information representative of a spatial position of at least one pixel contributing to the bin associated with one of said selected directional intra prediction modes and further based on information representative of a spatial position of at least one pixel contributing to the bin associated with another one of said selected directional intra prediction modes. In a specific example, the at least two predictions are blended based on information representative of the spatial positions of all the pixels contributing to the bin associated with at least one of said selected directional intra prediction modes.

In a step S210, the current picture block is reconstructed from the blended prediction on the decoder side. The reconstruction of the current picture block comprises adding the blended prediction to a decoded residual.

On the encoder side, the steps S200 to S210 apply in the same way as on the decoder side as the encoder comprises a so-called decoding loop. The blended prediction is also further used to obtain a residual that is further encoded (quantized and entropy coded). More precisely, the residual is obtained by a pixelwise subtraction of the blended prediction from the current picture block to be encoded.

In FIG. 11C, the flowchart can be decomposed into a step S300 of derivation of the information used to predict the current block to be coded via DIMD and a step S400 of prediction of the current block to be coded using all the information collected in S300. S300 comprises S200 and S202. S400 comprises S207, S208, and S210.

FIG. 11D is a flowchart of a method for reconstructing a picture block according to another example. The same method applies at both the encoder and decoder sides.

The method of FIG. 11D comprises the steps S200 to S202 and S207 to S210 of FIG. 11C. It comprises an additional step S204. At step S204, for at least one (e.g. for each) of said selected at least two directional intra prediction modes, information representative of a spatial position of at least one pixel is selected among the pixels contributing to the associated bin. The step S208 thus comprises blending the at least two predictions based on the spatial position represented by the information selected at step S204. More precisely, the at least two predictions are blended based on the information representative of a spatial position selected in S204.

In alternative implementation a blending matrix is explicitly obtained (S106 in FIG. 11E and FIG. 11F and S206 in FIG. 11G and FIG. 11H). Then, the at least two predictions are blended based on the blending matrices to obtain a blended prediction (S109 in FIG. 11E and FIG. 11F and S209 in FIG. 11G and FIG. 11H). Blending matrices are defined for the sake of clarity. However, explicitly obtaining blending matrices is not required for a practical implementation.

FIG. 11E is a flowchart of a method for reconstructing a picture block according to an example. The same method applies at both the encoder and decoder sides.

In a step S100, each directional intra prediction mode of a given set, e.g. the set of directional intra prediction modes defined in VVC, is associated with a sum of gradient values, e.g. |G_{HOR}|+|G_{VER}|, associated with pixels whose direction perpendicular to the gradient's direction is the closest to an orientation of said directional intra prediction mode and is further associated with information representative of a spatial position, e.g. spatial coordinates or more simply coordinates, of each pixel contributing to the sum. The considered pixels are located in context of a current picture block. The gradient values are for example equal to |G_{HOR}|+|G_{VER}|. However, the method is not limited to this value, e.g. \sqrt{|G_{HOR}|²+|G_{VER}|²} may be used instead. The associated values may be stored in a table or using a histogram.

As an example, for each decoded pixel of interest at which a local vertical gradient G_{VER} and a local horizontal gradient G_{HOR} are computed, a direction is derived from G_{VER} and G_{HOR} Which is perpendicular to the gradient's direction (i.e. the gradient's direction being the direction G of components G_{VER} and G_{HOR}), and the sum associated with the directional intra prediction mode whose direction is the closest to the derived direction is incremented.

In a step S102, at least two directional intra prediction modes associated with the sums of largest amplitude are selected.

In a step S106, for each of said selected at least two directional intra prediction modes, a blending matrix (also called blending kernel) is obtained from (e.g. responsive to) said spatial position of at least one pixel contributing to the sum associated with said selected directional intra prediction mode. In a specific example, the blending matrix (also called blending kernel) is obtained based on the spatial positions of all the pixels contributing to the sum associated with the selected directional intra prediction mode.

In a step S107, at least two predictions of the current picture block are obtained from the selected at least two directional intra prediction modes. In a variant, the step S107 applies just after S102, i.e. the at least two predictions are obtained just after the selection of the at least two directional intra prediction modes.

In a step S109, the at least two predictions are blended based on the blending matrices to obtain blended prediction.

In a step S110, the current picture block is reconstructed from the blended prediction on the decoder side. The reconstruction of the current picture block comprises adding the blended prediction to a decoded residual.

On the encoder side, the steps S100 to S110 apply in the same way as on the decoder side as the encoder comprises a so-called decoding loop. The blended prediction is also further used to obtain a residual that is further encoded (quantized and entropy coded). More precisely, the residual is obtained by a pixelwise subtraction of the blended prediction from the current picture block to be encoded.

FIG. 11F is a flowchart of a method for reconstructing a picture block according to another example. The same method applies at both the encoder and decoder sides.

The method of FIG. 11F comprises identical steps S100 to S102 and S106 to S110 as the method of FIG. 11E. It comprises an additional step S104. At step S104, for each of said selected at least two directional intra prediction modes, information representative of a spatial position of at least one pixel is selected among the pixels contributing to the associated sum.

The step S106 thus comprises obtaining, for each of said selected at least two directional intra prediction modes, a blending matrix based on (e.g. responsive to) said spatial position represented by the selected information.

FIG. 11G is a flowchart of a method for reconstructing a picture block according to an example. The same method applies at both the encoder and decoder sides.

In a step S200, a histogram of oriented gradient (HOG) is obtained from a context (also called template, e.g. a L-shape template), of a current picture block to be coded. Each bin of the histogram is associated with a directional intra prediction mode, e.g. with its index, and with information representative of a spatial position, e.g. coordinates, of each pixel contributing to the bin, also called reference location in the following sections. This example uses histogram of oriented gradient (HOG) to associate directional intra prediction modes with a sum of gradient's values.

In a step S202, at least two directional intra prediction modes associated with the bins of largest amplitude are selected.

In a step S206, for each of said selected at least two directional intra prediction modes, a blending matrix (also called blending kernel) is obtained based on (e.g. responsive to) said spatial position of at least one pixel contributing to the bin associated with said selected directional intra prediction mode. In a specific example, the blending matrix (also called blending kernel) is obtained based on the spatial positions of all the pixels contributing to the bin associated with the selected directional intra prediction mode.

In a step S207, at least two predictions of the current picture block are obtained based on the selected at least two directional intra prediction modes. In a variant, the step S207 applies just after S202, i.e. the at least two predictions are obtained just after the selection of the at least two directional intra prediction modes.

In a step S209, the at least two predictions are blended based on the blending matrices to obtain blended prediction.

In a step S210, the current picture block is reconstructed from the blended prediction on the decoder side. The reconstruction of the current picture block comprises adding the blended prediction to a decoded residual.

On the encoder side, the steps S200 to S210 apply in the same way as on the decoder side as the encoder comprises a so-called decoding loop. The blended prediction is also further used to obtain a residual that is further encoded (quantized and entropy coded). More precisely, the residual is obtained by a pixelwise subtraction of the blended prediction from the current picture block to be encoded.

In FIG. 11G, the flowchart can be decomposed into a step S300 of derivation of the information used to predict the current block to be coded via DIMD and a step S400 of prediction of the current block to be coded using all the information collected in S300. S300 comprises S200, S202, and S206. S400 comprises S207, S209 and S210.

FIG. 11H is a flowchart of a method for reconstructing a picture block according to another example. The same method applies at both the encoder and decoder sides.

The method of FIG. 11H comprises steps S200 to S202 and S206 to S210 of the method of FIG. 11G. It comprises an additional step S204. At step S204, for each of said selected at least two directional intra prediction modes, information representative of a spatial position of at least one pixel is selected among the pixels contributing to the associated bin.

The step S206 thus comprises obtaining, for each of said selected at least two directional intra prediction modes, a blending matrix based on said spatial position represented by the selected information.

In an example, information representative of a spatial position of each pixel contributing to the sum (bin respectively) comprises the spatial coordinates of said pixel.

In an example, context is a L-shape template.

In an example, selecting (S104), for each of said selected at least two directional intra prediction modes, information representative of a spatial position of at least one pixel comprises selecting information representative of a spatial position of a single pixel among the pixels contributing to the associated sum (bin respectively), said single pixel being the pixel associated with a largest gradient value.

In an example, selecting (S104), for each of said selected at least two directional intra prediction modes, information representative of a spatial position of at least one pixel comprises selecting information representative of a spatial position of a single pixel, said single pixel being the pixel closest to a reference pixel in said current picture block.

In an example, said reference pixel is the top left pixel of said current picture block.

In an example, obtaining (S106), for each of said selected at least two directional intra prediction modes, a blending matrix based on said spatial position of at least one pixel comprises defining a blending matrix whose coefficients linearly decrease from a center position towards vertical and horizontal spatial dimensions inside the current picture block, said center position being a position in the current picture block that is closest to the position of the selected single pixel.

In an example, obtaining (S106), for each of said selected at least two directional intra prediction modes, a blending matrix further comprises normalizing said blending matrix prior to blending.

Various examples of each step of the method illustrated by FIG. 11A to 11H are further detailed below. In the examples below, a bin or HOG bin may be considered as a sum of gradient's values associated with a particular directional mode. Therefore, a pixel contributing to a particular bin is equivalent to a pixel contributing to a particular sum.

1. Obtaining the HOG with the Reference Location (Steps S100 and S200)

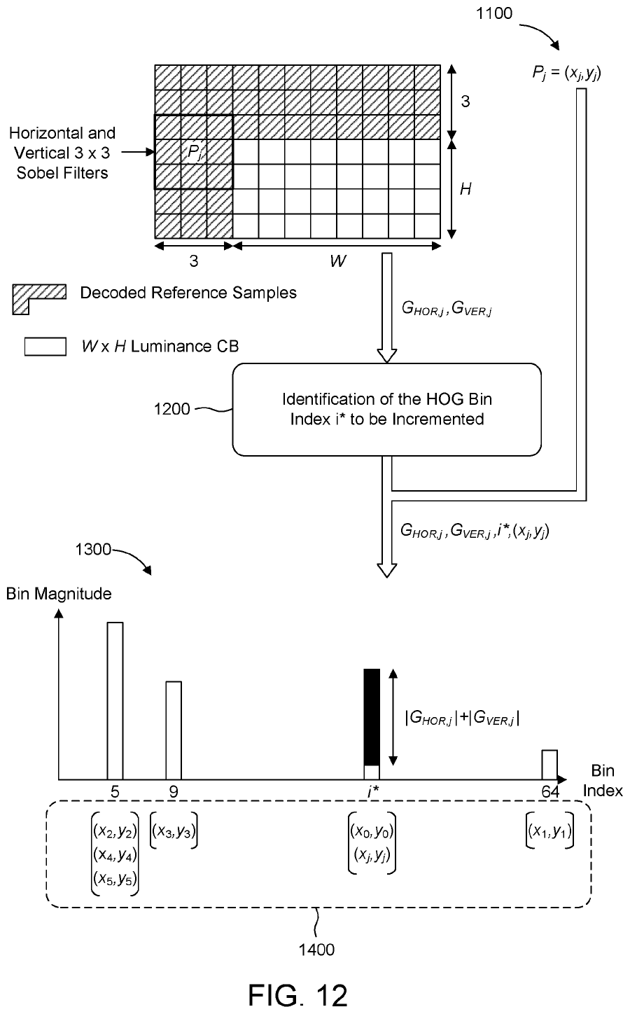

In an example depicted on FIG. 12, for a given current block (or CB) on which DIMD applies, at each location in the DIMD context at which a group of gradients is computed, the simultaneous incrementation of the HOG bin and the storage of this location applies. A reference location is thus the spatial position of a pixel at the center of gradient filters whose generated gradients contribute to a given HOG bin.

In the context of decoded reference samples around the current W×H luminance CB, the horizontal and vertical 3×3 Sobel filters are centered at position Pⱼ=(xⱼ, yⱼ) (1100), yielding the horizontal gradient G_{HOR} and the vertical gradient G_{VER}. Then, from G_{HOR} and G_{VER}, the HOG bin index i* to be incremented is obtained (1200). Then, the current HOG (1300) is updated by incrementing (incrementation is in displayed in grey on FIG. 12) its bin of index i* by |G_{HOR}|+|G_{VER}|. The HOG bins whose indices are not displayed are equal to 0. The array of “reference” locations (1400) is updated by appending to its sub-array of index i*the position (xⱼ, yⱼ) as depicted at the bottom of FIG. 12.

### Example 1: Array of “Reference” Locations with Equivalent Structure

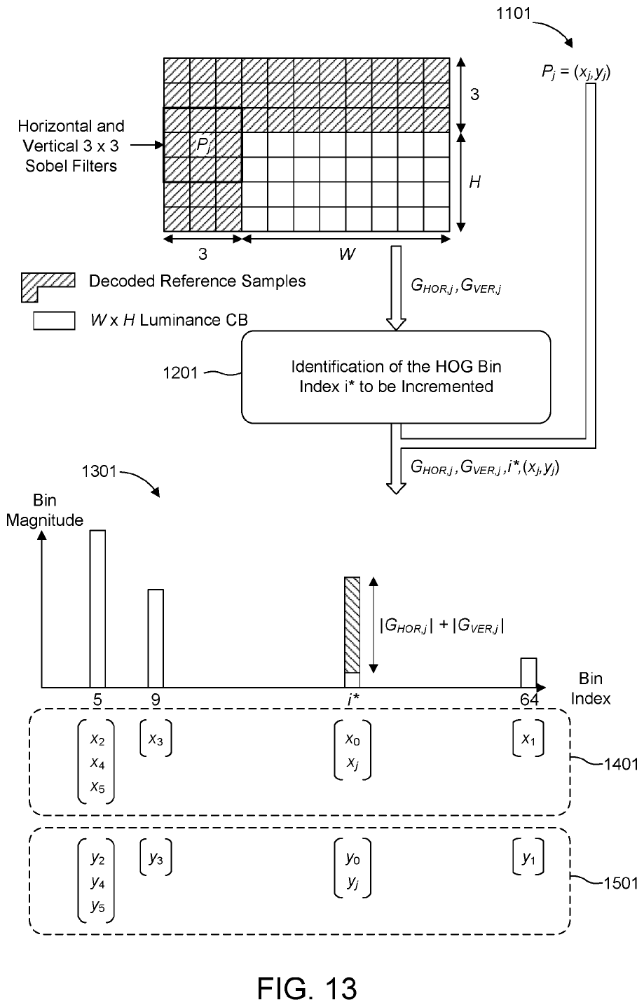

In FIG. 12, the array of “reference” locations, denoted arrRef, has two dimensions. Its first dimension is equal to 65, i.e. the number of directional intra prediction modes in VVC and ECM-6.0 (not considering the extended ones specific to Template-based Intra Mode Derivation (TIMD) in ECM-6.0). arrRef[i] stores the positions at which G_{HOR} and G_{VER} are computed, G_{HOR} and G_{VER} then causing an incrementation of HOG[i], i∈[[0, 64]]. In FIG. 13, the horizontal and vertical 3×3 Sobel filters are centered at position Pⱼ=(xⱼ, yⱼ) (1101), yielding the horizontal gradient G_{HOR} and the vertical gradient G_{VER}. Then, from G_{HOR} and G_{VER}, the HOG bin index i* to be incremented is obtained (1201). Then, the current HOG (1301) is updated by incremented its bin of index i* by |G_{HOR}|+|G_{VER}|.

However, the array of “reference” locations may have any equivalent structure. For instance, in an example depicted on FIG. 13, arrRef may be split into two arrays arrRefX and arrRefY, arrRefX storing only the column indices and arrRefY storing only the row indices. The array of “reference” locations (1400) in FIG. 12 may thus be split into arrRefX (1401) and arrRefY (1501) in FIG. 13.

### Example 2: Array of “Reference” Locations with Shifted Indexing

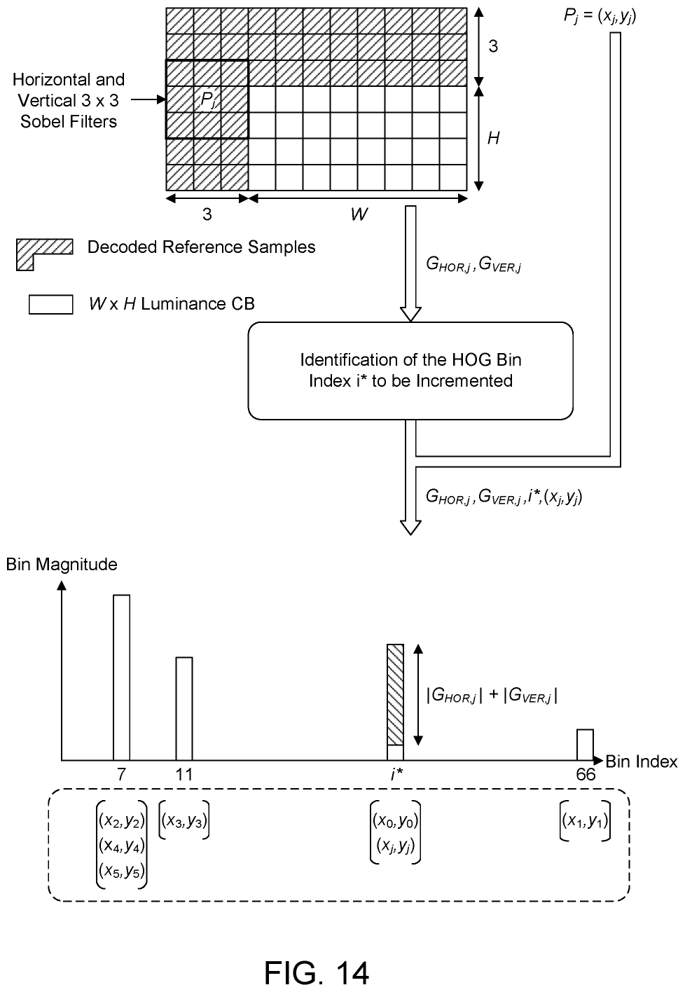

In FIG. 12, the array of “reference” locations and the HOG follow the same indexing. Precisely, the HOG bin of index j∈[[0,64]] and arrRef[j] are associated with the directional intra prediction mode of index j+2 in VVC and ECM-6.0. Instead, any equivalent indexing may be used. For instance, in an example depicted on FIG. 14, the HOG may contain 67 bins and the first dimension of the array of “reference” locations may be equal to 67. Then, the HOG bin of index j∈[[0, 66]] and arrRef[j] may be associated with the directional intra prediction mode of index j in VVC and ECM-6.0. j=0 and j=1 may then be unused.

### Example 3: HOG and Array of “Reference” Locations with Distinct Indexing

In another example, the array of “reference” locations and the HOG may follow two distinct ways of indexing, the correspondence between the two ways of indexing being known. For instance, for j∈[[0, 66]], the HOG bin of index j may be associated with the intra prediction mode of index j in VVC and ECM-6.0, arrRef[2j] may store the index of the column of each position at which the gradients are computed to generate the incrementations of HOG[j] whereas arrRef[2j=1] may store the index of the row of each of these positions.

### Example 4: Array of “Reference” Locations Also Storing Each HOG Increment

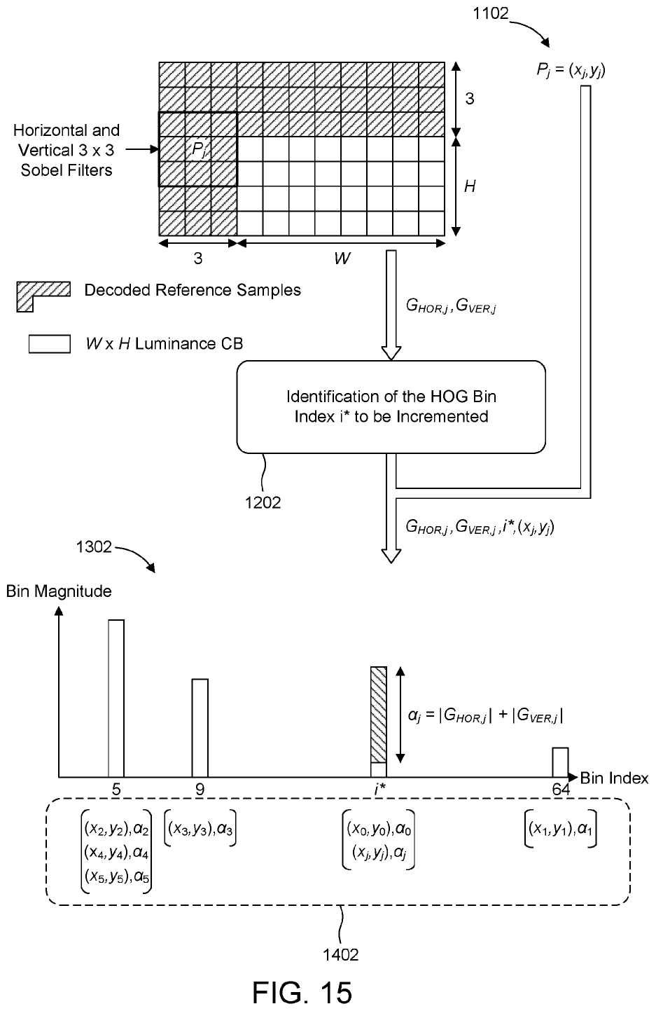

In another example depicted on FIG. 15, arrRef[j] stores the pair of the position at which the gradients are computed to generate the incrementation of HOG[j] and the incrementation value. In FIG. 15, the horizontal and vertical 3×3 Sobel filters are centered at position Pⱼ=(xⱼ, yⱼ) (1102), yielding the horizontal gradient G_{HOR} and the vertical gradient G_{VER}. Then, from G_{HOR} and G_{VER}, the HOG bin index i* to be incremented is obtained (1202).

In FIG. 15, the current HOG (1302) is updated by incremented its bin of index it by αⱼ=|G_{HOR}|+|G_{VER}|. The array of “reference” locations (1402) is updated by appending to its sub-array of index i* the pair of the position (xⱼ, yⱼ) and αⱼ. The value of αⱼ may be used in the example 6 to determine most relevant positions for DIMD blending.

### 2. Selecting the Directional Intra Prediction Modes Indices (S102 and S202)

In an example, for a given block on which DIMD applies, once the filling of the HOG is completed, the derivation of the DIMD modes indices while retrieving the location of each decoded pixel at which the gradient computation has led to an incrementation of the bins retained during the derivation may be applied within ECM-6.0 framework.

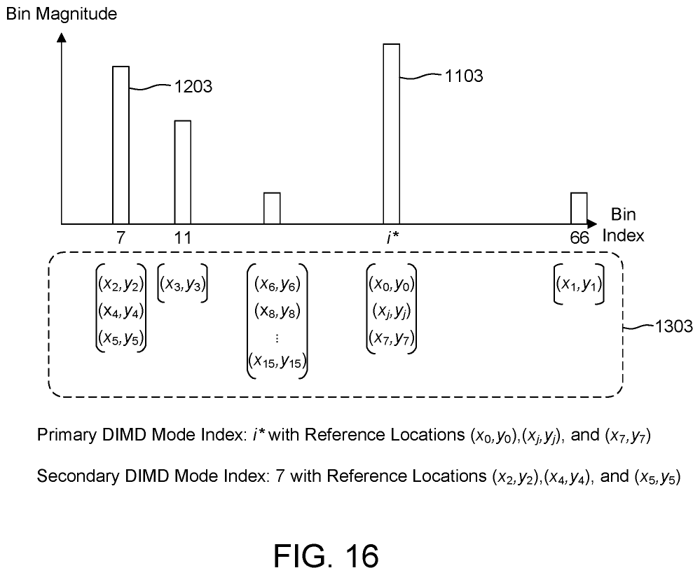

In FIG. 16, the HOG bin of index i* with the largest magnitude (1103) indicates that the primary DIMD mode index is i*. From the final array of “reference” locations (1303), the gradients computed at (x₀, y₀), (xⱼ, yⱼ) and (x₇, y₇) have contributed to the generation of bin (1103). The HOG bin (1203) of index 7 with the second largest magnitude indicates that the secondary DIMD mode index is 7. From the final array of “reference” locations (1303), the gradients computed at (x₂, y₂), (x₄, y₄) and (x₅, y₅) have contributed to the generation of bin (1203). Note that FIG. 16 illustrates the derivation of primary and secondary DIMD modes, wherein the array of “reference” locations are defined as disclosed in the example 2. However, FIG. 16 can be straightforwardly adapted to any of the previous examples 1 to 4.

### 3. DIMD Blending Driven by Reference Locations (S104, S204, S108. S208 and Optionally S106 and S206)

### Selecting the Most Relevant Positions (S104, S204)

Once the derivation of the DIMD modes indices is completed, the jth derived DIMD mode index, denoted idxⱼ (j∈ [symbol] 0,1 [symbol] in ECM-6.0 for primary and secondary DIMD modes respectively) is paired with a set of positions [symbol] ⱼ={(x₀^{j}, y₀^{j}), . . . , (xₜ_{^{j}}₋₁^{j}, yₜ_{^{j}}₋₁^{j})}, t^{j}∈ [symbol] denoting the number of incrementations of the HOG bin associated with idxⱼ. Then, to make the upcoming DIMD blending more robust, a rule f may take [symbol] ⱼ and return the reduced set of positions [symbol] . f may implement any reduction of [symbol] into [symbol] . Various examples of fare disclosed in the examples 5 to 7.

### Example 5: Decision to Cancel the DIMD Blending Depending on Pixel-Location

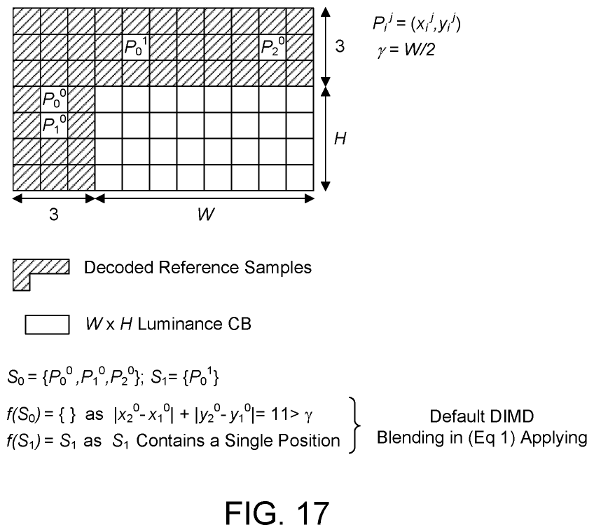

In an example illustrated on FIG. 17, for the jth derived DIMD mode index, f may cancel the DIMD blending depending on pixel-location if [symbol] ⱼ contains two positions with distance (e.g. Manhattan distance) larger than a threshold γ. In this case, the default DIMD blending in (Eq 1) applies. Otherwise, the DIMD blending depending on pixel-location applies.

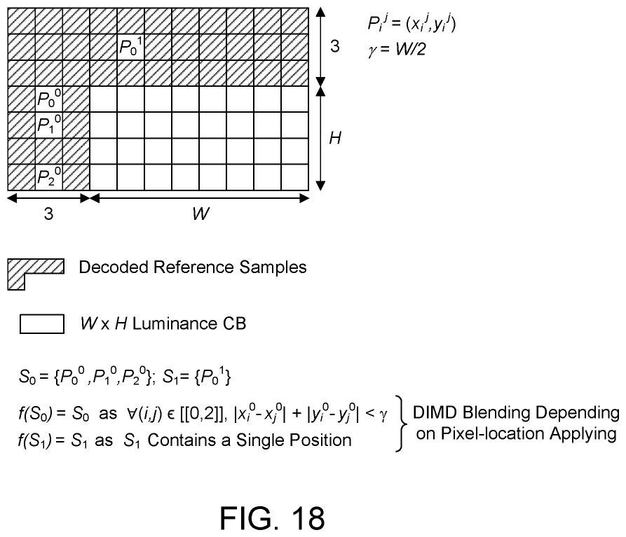

FIG. 17 applies this example to ECM-6.0. For the current W×H luminance CB, as [symbol] contains two positions with distance (e.g. Manhattan distance) larger than γ, the default DIMD blending in (Eq 1) applies. In FIG. 18, in both [symbol] and [symbol] , as there exists no pair of two positions with distance larger than γ, the DIMD blending depending on the pixel-location applies.

### Example 6: Reduction of Each Set of Positions to a Single Position

In an example, for the jth derived DIMD mode index, f may take [symbol] ⱼ and return the reduced set of positions [symbol] containing a single position. For instance, if the example 4 applies, the reduction may be based on the incrementation value associated with each position in [symbol] =f( [symbol] ⱼ)={(xₚ^{j}, yₚ^{j})} such that

$$p = {max}_{i ∈ 〚 0 , {t}^{j} - 1 , 〛} {α}_{i}^{j} .$$

This means that, f may keep in [symbol] ⱼ the position with the largest αᵢ^{j}, i.e. the position of largest gradient in absolute value.

### Example 7: Reduction of Each Set of Positions to a Single Position

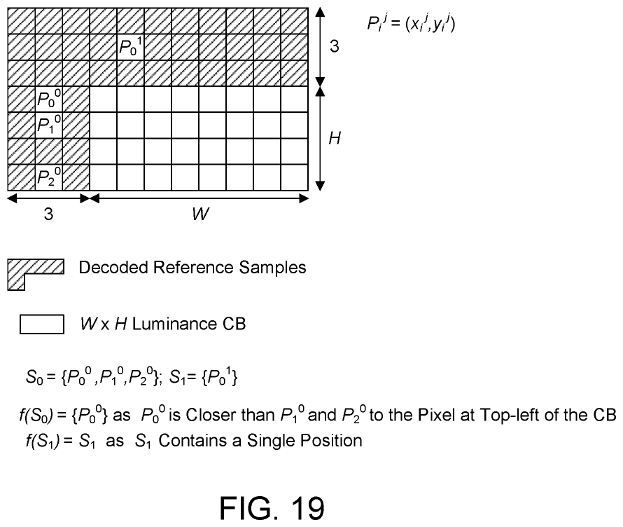

In an example, for the jth derived DIMD mode index, f may take [symbol] ⱼ and return the reduced set of positions [symbol] containing the single position that is the closest to a given “anchor” position. For instance, this given “anchor” position may be the position of the pixel at the top-left of the current block as depicted on FIG. 19. Therefore, f( [symbol] )={(x₀^{o}, y₀^{jo})}.

### Pixel-Location-Dependent Blending (Steps S108 and S208)

For consistency, the notations in (Eq 2) are reused. Finally, for the current W×H block, for the jth derived DIMD mode yielding the prediction dimdPredⱼ, the final DIMD prediction, denoted fusionPred, is obtained by weighting dimdPredⱼ using reference locations.

Pixel-Location-Dependent DIMD Blending without Explicit Blending Matrices

An example of a practical implementation of the blending at steps S108 or S208 of the at least two predictions based on at least one spatial position represented by the information representative of a spatial position selected at steps S104 or S204 is illustrated by pseudo-code 1. In this example, it is assumed that only two directional intra prediction modes have been selected at step S102 or S202. For a current W×H block, dimdPred₀ is the prediction of the current block using the first selected directional intra prediction mode, dimdPred₁ is the prediction of the current block using the second selected directional intra prediction mode and dimdPlanar is the prediction of the current block via a PLANAR mode. (xₚ⁰, yₚ⁰) is the position coming from the reduction to a single position for the first selected directional intra prediction mode as mentioned in Example 6, e.g. first DIMD mode. (xₚ¹, yₚ¹) is the position coming from the reduction to a single position for the second selected directional intra prediction mode (e.g. second DIMD mode). isBlendingLoc⁰ is true if the DIMD blending depending on pixel-location for the selected first DIMD mode is not canceled (see Example 5). isBlendingLoc¹ is true if the DIMD blending depending on pixel-location for the selected second DIMD mode is not canceled. The portions starting with // and in italics are comments for clarity. In the pseudo-code 1, i belongs to {0, 1}, 0) being associated with the selected first DIMD mode and 1 being associated with the selected second DIMD mode.

In pseudo-code 1, each weight constructed with the term

$${Δ}_{i} - 2 {Δ}_{i} \frac{\vert x - {\tilde{x}}_{p}^{i} \vert + \vert y - {\tilde{y}}_{p}^{i} \vert}{{dmax}^{i}}$$

depends only on the single position derived from the set of positions associated to the sum of gradients of the selected DIMD mode of index i∈{0, 1}, on the current position (x, y) within the final prediction of the current block, and the pre-defined range Δᵢ. Therefore, this ratio at each position within the final prediction of the current block is equivalent to a blending matrix.

In this pseudo-code 1, “a&&b” is the boolean logical “AND” operator that returns 1 only in the case where both a and b are true (i.e. not equal to 0), “a∥b” is the boolean logical OR operator that returns 1 in the case where either a or b equal 1 and thus a 0) if both a and b are false (i.e. equal to 0). “==” is an equality operator checking whether its two operands are equal, max(a,b) returns the highest values between a and b, min(a,b) returns the lowest values between a and b, “>>n” is a right shift by n bits. In pseudo-code 1, for the selected DIMD mode of index i, if isBlendingLocⁱ is true, dmaxⁱ is defined and corresponds to the largest distance inside the final prediction of the current block between the single position derived from the set of positions associated to the sum of gradients of the DIMD mode of index i and another block pixel.

```
Pseudo-code 1
if (isBlendingLocⁱ) // i in {0, 1}
{
  \tilde{x}ₚⁱ = min (max(0, xₚⁱ) , W − 1)
  \tilde{y}ₚⁱ = min (max(0, yₚⁱ) , H − 1)
  if (\tilde{x}ₚⁱ = = 0)
  {
    dmaxⁱ = W − 1 + max (H − 1 − \tilde{y}ₚⁱ, yₚⁱ)
  }
  else // \tilde{y}ₚⁱ equal to 0 in this case
  {
    dmaxⁱ = H − 1 + max (W − 1 − \tilde{x}ₚⁱ, \tilde{x}ₚⁱ)
  }
}
if (isBlendingLoc⁰ || isBlendingLoc¹)
{
if (isBlendingLoc⁰ && isBlendingLoc¹) // Pixel-location-dependent blending for the two
DIMD derived modes.
  {
  ${w}^{i} ( x , y ) = {wDimd}_{i} + {Δ}_{i} - 2 {Δ}_{i} \frac{\vert x - {{\tilde{x}}_{p}}^{i} \vert + \vert y - {{\tilde{y}}_{p}}^{i} \vert}{d {max}^{i}}$
  $wP ( x , y ) = 64 - {\sum }_{i = 0}^{1} {w}^{i} ( x , y )$
  $fusionPred ( x , y ) = ( {\sum }_{i = 0}^{1} \{ {w}^{i} ( x , y ) * {dimdPred}_{i} ( x , y ) \} + wP ( x , y ) *$
dimdPlanar(x,y) + 32) >> 6
  }
  else if (isBlendingLoc⁰) // Pixel-location-dependent blending only for the first DIMD
derived mode.
  {
  ${w}^{0} ( x , y ) = {wDimd}_{0} + {Δ}_{0} - 2 {Δ}_{0} \frac{\vert x - {{\tilde{x}}_{p}}^{0} \vert + \vert y - {{\tilde{y}}_{p}}^{0} \vert}{d {max}^{0}}$
  if (locDep₁ = = 1)
  {
  ${wLocDepDimd}_{1} ( x , y ) = {wDimd}_{1} + {Δ}_{1} - 2 {Δ}_{1} \frac{y}{( H - 1 )}$
  wP(x, y) = 64 − w⁰(x, y) wLocDepDimd₁(x, y)
  fusionPred(x, y) =
$( \begin{matrix}{w}^{0} ( x , y ) * {dimdPred}_{0} ( x , y ) + {wLocDepDimd}_{1} ( x , y ) * {dimdPred}_{1} ( x , y ) + \\ wP ( x , y ) * dimdPlanar ( x , y ) + 32\end{matrix} ) ≫ 6$
  }
  else if (locDep₁ = = 2)
  {
  ${wLocDepDimd}_{1} ( x , y ) = {wDimd}_{1} + {Δ}_{1} - 2 {Δ}_{1} \frac{x}{( W - 1 )}$
  wP(x, y) = 64 − w⁰(x, y) − wLocDepDimd₁(x, y)
  fusionPred(x, y) =
$( \begin{matrix}{w}^{0} ( x , y ) * {dimdPred}_{0} ( x , y ) + {wLocDepDimd}_{1} ( x , y ) * {dimdPred}_{1} ( x , y ) + \\ wP ( x , y ) * dimdPlanar ( x , y ) + 32\end{matrix} ) ≫ 6 \}$
  else
  {
    wP(x, y) = wPlanar + ((wDimd₀ − w⁰(x, y)) >> 1)
    w¹(x, y) = 64 − w⁰(x, y) − wP(x, y)
    $fusionPred ( x , y ) = ( {\sum }_{i = 0}^{1} \{ {w}^{i} ( x , y ) * {dimdPred}_{i} ( x , y ) \} + wP ( x , y ) *$
dimdPlanar(x,y) + 32) >> 6
    }
  }
else // Pixel-location-dependent blending only for the second DIMD derived mode.
  {
  ${w}^{1} ( x , y ) = w D i m {d}_{1} + {Δ}_{1} - 2 {Δ}_{1} \frac{\vert x - {\tilde{x}}_{p}^{1} \vert + \vert y - {\tilde{y}}_{p}^{1} \vert}{d {max}^{1}}$
    if (locDep₀ = = 1)
    {
    $w L o c D e p D i m {d}_{0} ( x , y ) = w D i m {d}_{0} + {Δ}_{0} - 2 {Δ}_{0} \frac{y}{( H - 1 )}$
    wP(x, y) = 64 − wLocDepDimd₀(x, y) − w¹(x, y)
    fusionPred(x, y) =
$( \begin{matrix}{wLocDepDimd}_{0} ( x , y ) * {dimdPred}_{0} ( x , y ) + {w}^{1} ( x , y ) * {dimdPred}_{1} ( x , y ) + \\ wP ( x , y ) * dimdPlanar ( x , y ) + 32\end{matrix} ) ≫ 6$
    }
    else if (locDep₀ = = 2)
    {
    $wLoc D e p D i m {d}_{0} ( x , y ) = w D i m {d}_{0} + {Δ}_{0} - 2 {Δ}_{0} \frac{x}{( W - 1 )}$
    wP(x, y) = 64 − wLocDepDimd₀(x, y) − w¹(x, y)
    fusionPred(x, y) =
$( \begin{matrix}{wLocDepDimd}_{0} ( x , y ) * {dimdPred}_{0} ( x , y ) + {w}^{1} ( x , y ) * {dimdPred}_{1} ( x , y ) + \\ wP ( x , y ) * dimdPlanar ( x , y ) + 32\end{matrix} ) ≫ 6$
  }
  else
  {
    wP(x, y) = wPlanar + ((wDimd₁ − w¹(x, y)) >> 1)
    w⁰(x, y) = 64 − w¹ (x, y) − wP(x, y)
    $fusionPred ( x , y ) ( {\sum }_{i = 0}^{1} \{ {w}^{i} ( x , y ) * {dimdPred}_{i} ( x , y ) \} + wP ( x , y ) *$
dimdPlanar(x,y) + 32) >> 6
    }
  }
}
else
{
// Blending as specified in section entitled ”Improved DIMD using sample-based weights to
blend the DIMD predictions”
}
```

### Integer Implementation of the Blendings

Pseudo-code 1 presents a floating-point implementation of the blending of the two predictions of the current block, yielding the final prediction of the current block. Indeed, as x∈[|0, W−1|], the ratio

$$\frac{x}{W - 1}$$

belongs to [0, 1]. As y∈[|0, H−1|], the ratio

$$\frac{y}{H - 1}$$

belongs to [0, 1]. Similarly, the ratio

$$\frac{\vert x - {\tilde{x}}_{p}^{i} \vert + \vert y - {\tilde{y}}_{p}^{i} \vert}{{dmax}^{i}}$$

belongs to [0, 1]. In a video codec, an integer implementation of this blending may be used. Table 1 presents a conversion of the three above-mentioned ratios from the floating-point implementation to an integer implementation. Using this conversion, Pseudo-code 1 can be adapted to a valid integer implementation of the blending.

TABLE 1

| floating-point | |
|---|---|
| implementation | integer implementation |
| $2 {Δ}_{i} \frac{\vert x - {\tilde{x}}_{p}^{i} \vert + \vert y - {\tilde{y}}_{p}^{i} \vert}{d {max}^{i}}$ | (2Δᵢ(\|x − \tilde{x}ₚⁱ\| + \|y − \tilde{y}ₚⁱ\|) + offsetdmax) >> log₂ (dmaxⁱ) |
| $2 {Δ}_{i} \frac{y}{( H - 1 )}$ | (2Δᵢy + offsetH) >> log₂ (H) |
| $2 {Δ}_{i} \frac{x}{( W - 1 )}$ | (2Δᵢx + offsetW) >> log₂(W) |

With offsetdmax = dmaxⁱ >> 1, offsetH = H >> 1 and offsetW = W >> 1

### Example 8: Integer Implementation with Coordinate Shift

According to another example, when the x coordinate reaches its maximum value W−1, x can be shifted by +1. When the y coordinate reaches its maximum value H−1, y can be shifted by +1. Table 2 illustrates the conversion of the three above-mentioned ratios from the floating-point implementation to an integer implementation with coordinate shift.

TABLE 2

| floating-point | |
|---|---|
| implementation | integer implementation with coordinate shift |
| $2 {Δ}_{i} \frac{\vert x - {\tilde{x}}_{p}^{i} \vert + \vert y - {\tilde{y}}_{p}^{i} \vert}{d {max}^{i}}$ | (2Δᵢ(\|x̅ − \tilde{x}ₚⁱ\| + \|y̅ − \tilde{y}ₚⁱ\|) + offsetdmax) >> log₂ (dmaxⁱ) |
| $2 {Δ}_{i} \frac{y}{( H - 1 )}$ | (2Δᵢy̅ + offsetH) >> log₂ (H) |
| $2 {Δ}_{i} \frac{x}{( W - 1 )}$ | (2Δᵢx̅ + offsetW) >> log₂(W) |

With x̅ = (x = = W − 1) ? W:x and y̅ = (y = = H − 1) ? H:y , where a ? b:c means: if a
is True, returns b else returns c.

### Example 9: Integer Implementation with Another Coordinate Shift

According to another example, when the x coordinate exceeds a given value γ, x can be shifted by nₓ∈ [symbol] . When the y coordinate exceeds a given value δ, y can be shifted by n_{y}∈ [symbol] . Table 3 illustrates the conversion of the three above-mentioned ratios from the floating-point implementation to an integer implementation with coordinate shift,

$$γ = \frac{W}{2} , {n}_{x} = 1 , δ = \frac{H}{2} , {n}_{y} = 1.$$

TABLE 3

| floating-point | |
|---|---|
| implementation | integer implementation with coordinate shift |
| $2 {Δ}_{i} \frac{\vert x - {\tilde{x}}_{p}^{i} \vert + \vert y - {\tilde{y}}_{p}^{i} \vert}{d {max}^{i}}$ | (2Δᵢ(\|x̅ − \tilde{x}ₚⁱ\| + \|y̅ − \tilde{y}ₚⁱ\|) + offsetdmax) >> log₂ (dmaxⁱ) |
| $2 {Δ}_{i} \frac{y}{( H - 1 )}$ | (2Δᵢy̅ + offsetH) >> log₂ (H) |
| $2 {Δ}_{i} \frac{x}{( W - 1 )}$ | (2Δᵢx̅ + offsetW) >> log₂(W) |

With x̅ = x > offsetW ? x + 1:x and y̅ = y > offsetH ? y + 1:y

Pixel-Location-Dependent DIMD Blending with Blending Matrices

In an optional first step the most relevant positions are selected (S104). In an optional second step a blending kernel (also called blending matrix) is obtained (S106) for each of the selected positions and the blending kernels involving the reference locations are normalized to get the final blending matrix. In a third step, the predictions are blended.

### Obtaining the Blending Kernels (Step S106)

For the current block, for the jth derived DIMD mode index, for each position in [symbol] , its kernel characterizes the weight of the prediction via the jth derived DIMD mode at each spatial location in the current block. For simplicity, let us say that, for the jth derived DIMD mode index, [symbol] stores a single position. Then, the jth derived DIMD mode index is associated with a single kernel [symbol] . The kernel [symbol] of the jth derived DIMD mode index may be defined by any formula [symbol] (x, y) and be centered at any position within either the current block or its DIMD context. The following four examples propose relevant choices.

Kernel Linearly Decreasing from its Center

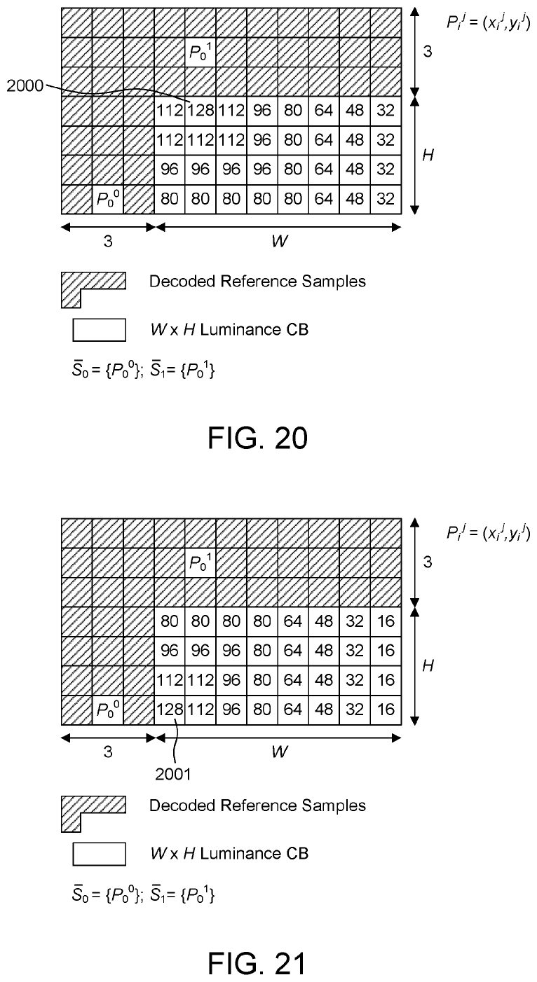

In an example, the kernel [symbol] of the jth derived DIMD mode index linearly decreases from its center towards the two spatial dimensions inside the current block. More precisely, its coefficients linearly decrease from a center position towards vertical and horizontal spatial dimensions inside the current picture block, said center position being a position in the current picture block that is closest to the position of the selected single pixel. FIGS. 20 and 21 illustrate this example for the current W×H luminance CB. In FIG. 20, the kernel [symbol] for the single position P₀¹ in [symbol] has value 128 at its center (2000) and decreases by 16 at each one-pixel step away from its center. In FIG. 21, the kernel [symbol] for the single position P₀⁰ in [symbol] has value 128 at its center (2001) and decreases by 16 at each one-pixel step away from its center. Depending on the values of W and H, the decrement at each one-pixel step away from the kernel center may be adjusted.

Kernel with a Spatial Cut Value

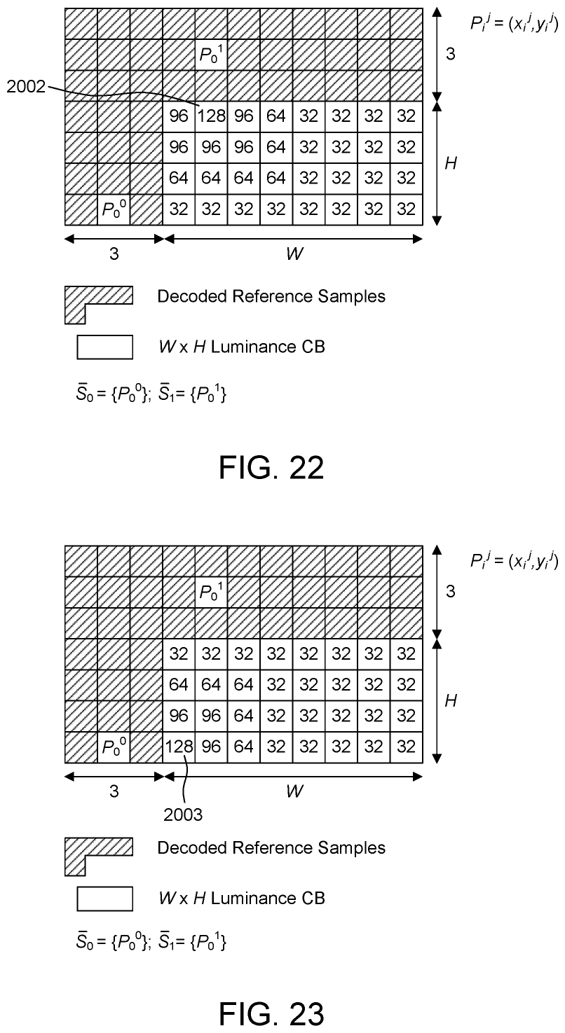

In an example, the kernel K; of the jth derived DIMD mode index linearly decreases from its center towards the two spatial dimensions inside the current block until a given cut value is reached. If, in FIG. 20, the decrement at each one-pixel step away from the kernel center is set to 32 and the spatial cut value is set to 32, the kernel depicted on FIG. 22 is obtained with its center (2002). More precisely, FIG. 22 depicts a kernel [symbol] for the single position P₀¹ in [symbol] , involving a cut value at 32, for the current W×H luminance CB.

If, in FIG. 21, the decrement at each one-pixel step away from the kernel center is set to 32 and the spatial cut value is set to 32, the kernel depicted FIG. 23 is obtained with its center (2003). More precisely, FIG. 23 depicts a kernel [symbol] for the single position P₀⁰ in [symbol] , involving a cut value at 32, for the current W×H luminance CB.

### Kernel Defined as a Discretized Gaussian

In an example, the kernel [symbol] of the jth derived DIMD mode index corresponds to a discretized version of a Gaussian with given standard deviation, e.g. 4.

Kernel Centered at the Position in the Current Block that is the Closest to its Associated Position

In an example, the kernel [symbol] of the jth derived DIMD mode index is centered at the position in the current block that is the closest to the single position in [symbol] . For instance, in FIG. 20, the center (2000) of [symbol] is the closest position to P₀¹ inside the current luminance CB. In FIG. 21, the center (2001) of [symbol] is the closest position to P₀⁰ inside the current luminance CB.

### Normalizing the Blending Kernels Involving the Selected Location (Step S106)

Now that, for the current W×H block, the jth derived DIMD mode index has a well-defined kernel for its position in [symbol] , the last step comprises normalizing the blending kernels. If the blending kernels were in floating-point, [symbol] would be normalized into [symbol] such that [symbol] [symbol] +planarWeight_{float}=1 s, 1 s being the W×H matrix filled with ones. planarWeight_{float} is the given weight (in floating-point) for blending the prediction of the current luminance CB via PLANAR. For instance, for j∈ [symbol] 0,n−1 [symbol] ,

$$\overline{{𝒦}_{j}} = \frac{{𝒦}_{j}}{{\sum }_{i ∈ 〚 0 , n - 1 〛} {𝒦}_{i} + {planarWeight}_{float}}$$

Preferentially, [symbol] contains integers to be used in a video codec.

### Normalizing the Integer Blending Kernels

In an example compliant with ECM-6.0, for the current W×H luminance CB, the kernel [symbol] of the derived DIMD primary mode index and the kernel [symbol] of the derived DIMD secondary mode index may be normalized into [symbol] and [symbol] using an integerization function equivalent to the one already used by the DIMD blending. This means that, for each position (x, y) in the current W×H luminance CB, [symbol] (x, y) and [symbol] (x, y) may be obtained from [symbol] (x, y), [symbol] (x, y), and planarWeightᵢₙₜ via the algorithm disclosed below. planarWeightᵢₙₜ is the given weight (in integer) for blending the prediction of the current luminance CB via PLANAR. For instance, planarWeightᵢₙₜ=21. Note that, in the Algorithm 1 disclosed below, [symbol] (x, y) and [symbol] (x, y) belongs to [|0, 64|]. “floorLog2” computes the logarithm basis 2 of this input and applies “floor” to the resulting value.

Algorithm 1
Inputs: [symbol] (x, y), [symbol] (x, y), and planarWeightᵢₙₜ
Outputs: [symbol] (x, y), [symbol] (x, y).
static const int arrayDivision[16] = {0, 7, 6, 5, 5, 4, 4, 3, 3, 2, 2, 1, 1, 1, 1, 0};
const int sumWeight{64 − planarWeightᵢₙₜ);
const uint64_t sum_values { [symbol] (x, y) + [symbol] (x, y)};
int log2_sum_values{floorLog2(sum_values)};
const int norm_log2_sum_values{static_cast<int>((sum_values << 4) >> log2_sum_values) &
15};
const int multiplier{arrayDivision[norm_log2_sum_values] | 8};
log2_sum_values += (norm_log2_sum_values != 0);
const int shift{log2_sum_values + 3};
const int offset{1 << (shift − 1)}; [symbol]
(x, y) = ( [symbol] (x, y)*multiplier*sumWeight + offset) >> shift;
if ( [symbol] (x, y) > sumWeight)
{ [symbol]
(x, y) = sumWeight;
} [symbol]
(x, y) = sumWeight − [symbol] (x, y);

Various examples are disclosed below for the blending using the blending matrices

The final DIMD prediction, denoted fusionPred, is obtained by weighting dimdPredⱼ using reference locations, and more precisely with [symbol] .

### Pixel-Location-Dependent DIMD Blending Involving Only the Proposed Kernels and the Weight for PLANAR

In an example compliant with ECM-6.0, for the current W×H luminance CB, the final DIMD prediction fusionPred of the current luminance CB may be

$$fusionPred ( x , y ) = ( \begin{matrix}{\sum }_{i = 0}^{1} \{ \overline{{𝒦}_{l}} ( x , y ) * {dimdPred}_{i} ( x , y ) \} \\ + {planarWeight}_{int} * dimdPlanar ( x , y ) + 32\end{matrix} ) ≫ 6$$

### Pixel-Location-Dependent DIMD Blending Involving Only the Proposed Kernels

In an example compliant with ECM-6.0, for the current W×H luminance CB, the final DIMD prediction fusionPred of the current luminance CB may be

$$fusionPred ( x , y ) = ( {\sum }_{i = 0}^{1} \{ \overline{{𝒦}_{l}} ( x , y ) * {dimdPred}_{i} ( x , y ) \} + 32 ) ≫ 6$$

In this case, in Algorithm 1, planarWeightᵢₙₜ is equal to 0.

Pixel-location-dependent DIMD blending involving both the proposed kernels, the original uniform DIMD weights, and the weight for PLANAR

In an example compliant with ECM-6.0, for the current W×H luminance CB, the final DIMD prediction fusionPred of the current luminance CB may be

$$fusionPred ( x , y ) = ( \begin{matrix}{\sum }_{i = 0}^{1} \{ ( ( \overline{{𝒦}_{l}} ( x , y ) + {wDimd}_{i} ( x , y ) ) ≫ 1 ) * {dimdPred}_{i} ( x , y ) \} \\ + {planarWeight}_{int} * dimdPlanar ( x , y ) + 32\end{matrix} ) ≫ 6$$

wDimdᵢ denotes the original uniform DIMD weight for dimdPredᵢ.

Note that the above formulation assumes that the same value for planarWeightᵢₙₜ is used in Algorithm 1 and inside the integer-normalization yielding the {wDimdᵢ(x, y)} [symbol] in ECM-6.0.

This last example disclosed an exemplar pixel-location-dependent DIMD blending involving the proposed kernels, the original uniform DIMD weights, and the weight for PLANAR.

However, any other formula for combining [symbol] (x, y), wDimdᵢ(x, y), and planarWeightᵢₙₜ may be used.

Note that, in the three previous examples, the last two operations to compute fusionPred (x, y) are an addition with 32 and a right-bitshifting by 6 of the result of this addition. However, the values 32 and 6 depend on the definition of the blending kernels [symbol] , (x, y), the definition of wDimdᵢ(x, y), the definition of planarWeightᵢₙₜ, and the normalization algorithm. For instance, if [symbol] (x, y), wDimdᵢ(x, y), planarWeightᵢₙₜ are scaled by 2 with respect to the previous definitions and Algorithm 1 is adapted accordingly, 32 is thus replaced by 64 and the right-bitshifting by 6 is replaced by a right-bitshifting by 7.

Any of the above-mentioned example for DIMD applying to a given W×H luminance CB can be straightforwardly generalized to DIMD applying to a given pair of W×H chrominance CBs.

Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, decode re-sampling filter coefficients, re-sampling a decoded picture, or for example, associating, with each directional intra prediction mode of a set, a sum of gradient's values associated with pixels whose direction perpendicular to gradient's direction is closest to a direction of said directional intra prediction mode and information representative of a spatial position of each pixel contributing to the sum, wherein said pixels are located in a context of a current picture block: selecting at least two directional intra prediction modes associated with sums of largest amplitude: obtaining at least two predictions of said current picture block from said selected at least two directional intra prediction modes: blending the at least two predictions based on information representative of a spatial position of at least one pixel contributing to the sum associated with at least one of said selected directional intra prediction modes to obtain a blended prediction; and reconstructing the current picture block from the blended prediction.

As further examples, in one example “decoding” refers only to entropy decoding, in another example “decoding” refers only to differential decoding, and in another example “decoding” refers to a combination of entropy decoding and differential decoding, and in another example “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining re-sampling filter coefficients, re-sampling a decoded picture, or associating, with each directional intra prediction mode of a given set, a sum of gradient's values associated with pixels whose direction perpendicular to gradient's direction is the closest to a direction of said directional intra prediction mode and information representative of a spatial position of each pixel contributing to the sum, wherein said pixels are located in context of a current picture block; selecting at least two directional intra prediction modes associated with the sums of largest amplitude; obtaining at least two predictions of said current picture block from said selected at least two directional intra prediction modes; blending the at least two predictions based on information representative of a spatial position of at least one pixel contributing to the sum associated with at least one of said selected directional intra prediction modes to obtain a blended prediction; and encoding the current picture block from the blended prediction.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS (Sequence Parameter Set), a PPS (Picture Parameter Set), a NAL unit (Network Abstraction Layer), a header (for example, a NAL unit header, or a slice header) or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some examples may refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information.

Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in some examples the encoder signals a particular one of a plurality of re-sampling filter coefficients, or an encoded block. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various examples. It is to be appreciated that signaling can be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described example. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of examples has been described above. Features of these examples can be provided alone or in any combination, across various claim categories and types.

A decoding method comprising:
associating, with each directional intra prediction mode of a set, a sum of gradient's values associated with pixels whose direction perpendicular to gradient's direction is closest to a direction of said directional intra prediction mode and information representative of a spatial position of each pixel contributing to the sum, wherein said pixels are located in a context of a current picture block;
selecting at least two directional intra prediction modes associated with sums of largest amplitude;
obtaining at least two predictions of said current picture block from said selected at least two directional intra prediction modes;
blending the at least two predictions based on information representative of a spatial position of at least one pixel contributing to the sum associated with at least one of said selected directional intra prediction modes to obtain a blended prediction; and
reconstructing the current picture block from the blended prediction.

In an example, associating, with each directional intra prediction mode of a set, a sum of gradient's values comprises obtaining a histogram of oriented gradient, wherein each bin of said histogram is associated with a directional intra prediction mode and with information representative of a spatial position of each pixel contributing to the bin.

In an example, the decoding method comprises selecting, for at least one of said selected at least two directional intra prediction modes, information representative of a spatial position of at least one pixel among the pixels contributing to the associated sum and blending the at least two predictions comprises blending the at least two predictions based on said selected information.

In an example, said information representative of a spatial position of each pixel contributing to the sum comprises spatial coordinates of said pixel.

In an example, said context is a L-shape template.

In an example, selecting, for at least one of said selected at least two directional intra prediction modes, information representative of a spatial position of at least one pixel comprises selecting information representative of a spatial position of a single pixel among the pixels contributing to the associated sum, said single pixel being the pixel associated with a largest gradient value. In an example, selecting, for at least one of said selected at least two directional intra prediction modes, information representative of a spatial position of at least one pixel comprises selecting information representative of a spatial position of a single pixel among the pixels contributing to the associated sum, said single pixel being the pixel closest to a reference pixel in said current picture block.

In an example, said reference pixel is a top left pixel of said current picture block.

In an example, blending the at least two predictions comprises:
obtaining, for each of said selected at least two directional intra prediction modes, a blending matrix based on said spatial position of at least one pixel contributing to the sum associated with said selected directional intra prediction mode; and
blending the at least two predictions based on said blending matrices.

In an example, obtaining, for each of said selected at least two directional intra prediction modes, a blending matrix comprises obtaining a blending matrix whose coefficients linearly decrease from a center position towards vertical and horizontal spatial dimensions inside the current picture block, said center position being a position in the current picture block that is closest to the position of a selected single pixel.

In an example, obtaining, for each of said selected at least two directional intra prediction modes, a blending matrix further comprises normalizing said blending matrix prior to blending.

An encoding method is disclosed that comprises:
associating, with each directional intra prediction mode of a given set, a sum of gradient's values associated with pixels whose direction perpendicular to gradient's direction is the closest to a direction of said directional intra prediction mode and information representative of a spatial position of each pixel contributing to the sum, wherein said pixels are located in context of a current picture block;
selecting at least two directional intra prediction modes associated with the sums of largest amplitude;
obtaining at least two predictions of said current picture block from said selected at least two directional intra prediction modes;
blending the at least two predictions based on information representative of a spatial position of at least one pixel contributing to the sum associated with at least one of said selected directional intra prediction modes to obtain a blended prediction; and
encoding the current picture block from the blended prediction.

In an example, associating, with each directional intra prediction mode of a set, a sum of gradient's values comprises obtaining a histogram of oriented gradient, wherein each bin of said histogram is associated with a directional intra prediction mode and with information representative of a spatial position of each pixel contributing to the bin.

In an example, the encoding method comprising selecting (S104), for at least one of said selected at least two directional intra prediction modes, information representative of a spatial position of at least one pixel among the pixels contributing to the associated sum and wherein blending the at least two predictions comprises blending (S108) the at least two predictions based on said selected information.

In an example, said information representative of a spatial position of each pixel contributing to the sum comprises spatial coordinates of said pixel.

In an example, said context is a L-shape template.

In an example, selecting, for at least one of said selected at least two directional intra prediction modes, information representative of a spatial position of at least one pixel comprises selecting information representative of a spatial position of a single pixel among the pixels contributing to the associated sum, said single pixel being the pixel associated with a largest gradient value.

In an example, selecting, for at least one of said selected at least two directional intra prediction modes, information representative of a spatial position of at least one pixel comprises selecting information representative of a spatial position of a single pixel among the pixels contributing to the associated sum, said single pixel being the pixel closest to a reference pixel in said current picture block.

In an example, said reference pixel is a top left pixel of said current picture block.

In an example, blending the at least two predictions comprises:
obtaining, for each of said selected at least two directional intra prediction modes, a blending matrix based on said spatial position of at least one pixel contributing to the sum associated with said selected directional intra prediction mode; and
blending the at least two predictions based on said blending matrices.

In an example, obtaining, for each of said selected at least two directional intra prediction modes, a blending matrix comprises obtaining a blending matrix whose coefficients linearly decrease from a center position towards vertical and horizontal spatial dimensions inside the current picture block, said center position being a position in the current picture block that is closest to the position of a selected single pixel.

In an example, obtaining, for each of said selected at least two directional intra prediction modes, a blending matrix further comprises normalizing said blending matrix prior to blending.

A decoding apparatus is disclosed that comprises one or more processors and at least one memory coupled to said one or more processors, wherein said one or more processors are configured to perform the decoding method.

An encoding apparatus is disclosed that comprises one or more processors and at least one memory coupled to said one or more processors, wherein said one or more processors are configured to perform the encoding method.

A computer program is disclosed that comprises program code instructions for implementing the encoding or decoding method when executed by a processor.

A computer readable storage medium is disclosed that has stored thereon instructions for implementing the encoding or decoding method.

1. A decoding method comprising:
associating, with each directional intra prediction mode of a set, a sum of gradient's values associated with pixels whose direction perpendicular to gradient's direction is closest to a direction of the directional intra prediction mode and information representative of spatial coordinates of each pixel contributing to the sum, wherein the pixels are located in a context of a current picture block;
selecting at least two directional intra prediction modes associated with the sums of largest amplitude;
obtaining at least two predictions of the current picture block from the selected at least two directional intra prediction modes;
blending the at least two predictions based on information representative of spatial coordinates of at least one pixel contributing to the sum associated with at least one of the selected at least two directional intra prediction modes to obtain a blended prediction; and
reconstructing the current picture block from the blended prediction.

2. The method of claim 1, wherein associating, with each directional intra prediction mode of a set, a sum of gradient's values comprises obtaining a histogram of oriented gradient, wherein each bin of the histogram is associated with a directional intra prediction mode and with information representative of spatial coordinates of each pixel contributing to the bin.

3. The method of claim 1, comprising selecting, for at least one of the selected at least two directional intra prediction modes, information representative of spatial coordinates of at least one pixel among the pixels contributing to the associated sum and wherein blending the at least two predictions comprises blending the at least two predictions based on the selected information.

4-5. (canceled)

6. The method according to claim 3, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel associated with a largest gradient value.

7. The method according to claim 3, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel closest to a reference pixel in the current picture block.

8. (canceled)

9. The method of claim 1, wherein blending the at least two predictions comprises:
obtaining, for each of the selected at least two directional intra prediction modes, a blending matrix based on the spatial coordinates of at least one pixel contributing to the sum associated with the selected directional intra prediction mode; and
blending the at least two predictions based on the blending matrices.

10-11. (canceled)

12. An encoding method comprising:
associating, with each directional intra prediction mode of a set, a sum of gradient's values associated with pixels whose direction perpendicular to gradient's direction is closest to a direction of the directional intra prediction mode and information representative of spatial coordinates of each pixel contributing to the sum, wherein the pixels are located in a context of a current picture block;
selecting at least two directional intra prediction modes associated with the sums of largest amplitude;
obtaining at least two predictions of the current picture block from the selected at least two directional intra prediction modes;
blending the at least two predictions based on information representative of spatial coordinates of at least one pixel contributing to the sum associated with at least one of the selected at least two directional intra prediction modes to obtain a blended prediction; and
encoding the current picture block from the blended prediction.

13. The method of claim 12, wherein associating, with each directional intra prediction mode of a set, a sum of gradient's values comprises obtaining a histogram of oriented gradient, wherein each bin of the histogram is associated with a directional intra prediction mode and with information representative of spatial coordinates of each pixel contributing to the bin.

14. The method of claim 12, comprising selecting, for at least one of the selected at least two directional intra prediction modes, information representative of spatial coordinates of at least one pixel among the pixels contributing to the associated sum and wherein blending the at least two predictions comprises blending the at least two predictions based on the selected information.

15-16. (canceled)

17. The method according to claim 14, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel associated with a largest gradient value.

18. The method according to claim 14, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel closest to a reference pixel in the current picture block.

19. (canceled)

20. The method of claim 12, wherein blending the at least two predictions comprises:
obtaining, for each of the selected at least two directional intra prediction modes, a blending matrix based on the spatial coordinates of at least one pixel contributing to the sum associated with the selected directional intra prediction mode; and
blending the at least two predictions based on the blending matrices.

21-22. (canceled)

23. A decoding apparatus comprising one or more processors and at least one memory coupled to the one or more processors, wherein the one or more processors are configured to perform:
associating, with each directional intra prediction mode of a set, a sum of gradient's values associated with pixels whose direction perpendicular to gradient's direction is closest to a direction of the directional intra prediction mode and information representative of spatial coordinates of each pixel contributing to the sum, wherein the pixels are located in a context of a current picture block;
selecting at least two directional intra prediction modes associated with the sums of largest amplitude;
obtaining at least two predictions of the current picture block from the selected at least two directional intra prediction modes;
blending the at least two predictions based on information representative of spatial coordinates of at least one pixel contributing to the sum associated with at least one of the selected at least two directional intra prediction modes to obtain a blended prediction; and
reconstructing the current picture block from the blended prediction.

24. An encoding apparatus comprising one or more processors and at least one memory coupled to the one or more processors, wherein the one or more processors are configured to perform:
associating, with each directional intra prediction mode of a set, a sum of gradient's values associated with pixels whose direction perpendicular to gradient's direction is closest to a direction of the directional intra prediction mode and information representative of spatial coordinates of each pixel contributing to the sum, wherein the pixels are located in a context of a current picture block;
selecting at least two directional intra prediction modes associated with the sums of largest amplitude;
obtaining at least two predictions of the current picture block from the selected at least two directional intra prediction modes;
blending the at least two predictions based on information representative of spatial coordinates of at least one pixel contributing to the sum associated with at least one of the selected at least two directional intra prediction modes to obtain a blended prediction; and
encoding the current picture block from the blended prediction.

25-26. (canceled)

27. The decoding apparatus of claim 23, wherein associating, with each directional intra prediction mode of a set, a sum of gradient's values comprises obtaining a histogram of oriented gradient, wherein each bin of the histogram is associated with a directional intra prediction mode and with information representative of spatial coordinates of each pixel contributing to the bin.

28. The decoding apparatus of claim 23, wherein the one or more processors are further configured to perform selecting, for at least one of the selected at least two directional intra prediction modes, information representative of spatial coordinates of at least one pixel among the pixels contributing to the associated sum and wherein blending the at least two predictions comprises blending the at least two predictions based on the selected information.

29. The decoding apparatus according to claim 28, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel associated with a largest gradient value.

30. The decoding apparatus according to claim 28, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel closest to a reference pixel in the current picture block.

31. The decoding apparatus of claim 23, wherein blending the at least two predictions comprises:
obtaining, for each of the selected at least two directional intra prediction modes, a blending matrix based on the spatial coordinates of at least one pixel contributing to the sum associated with the selected directional intra prediction mode; and
blending (S108) the at least two predictions based on the blending matrices.

32. The encoding apparatus of claim 24, wherein associating, with each directional intra prediction mode of a set, a sum of gradient's values comprises obtaining a histogram of oriented gradient, wherein each bin of the histogram is associated with a directional intra prediction mode and with information representative of spatial coordinates of each pixel contributing to the bin.

33. The encoding apparatus of claim 24, wherein the one or more processors are further configured to perform selecting, for at least one of the selected at least two directional intra prediction modes, information representative of spatial coordinates of at least one pixel among the pixels contributing to the associated sum and wherein blending the at least two predictions comprises blending the at least two predictions based on the selected information.

34. The encoding apparatus according to claim 33, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel associated with a largest gradient value.

35. The encoding apparatus according to claim 33, wherein selecting, for at least one of the selected at least two directional intra prediction modes, information representative of spatial coordinates of at least one pixel comprises selecting information representative of spatial coordinates of a single pixel among the pixels contributing to the associated sum, the single pixel being the pixel closest to a reference pixel in the current picture block.

36. The encoding apparatus of claim 24, wherein blending the at least two predictions comprises:
obtaining, for each of the selected at least two directional intra prediction modes, a blending matrix based on the spatial coordinates of at least one pixel contributing to the sum associated with the selected directional intra prediction mode; and
blending the at least two predictions based on the blending matrices.
